(19) United States
(12) Patent Application Publication
(10) Pub. No.: US 2007/0129234 A1
(43) Pub. Date: Jun. 7, 2007

(54) Lower temperature CO promoters for FCC with low NOx

(76) Inventor: David Matheson Stockwell, Westfield, NJ (US)

Correspondence Address: BASF Catalysts LLC;Attention: Chief Patent Counsel, 101 Wood Avenue, P.O. Box 770, Iselin, NJ, 08830-0770, US

(21) Appl. No.: 11/602,855

(22) Filed: Nov. 21, 2006

Related U.S. Application Data
(60) Provisional application No. 60/742,213, filed on Dec. 5, 2005.

(51) Int. Cl. B01J 20/34

(52) U.S. Cl. 502/34; 502/339

(57) ABSTRACT

A carbon monoxide oxidation promoter for use in an FCC regenerator comprises a mixture of base metal oxides, which are present in an amount so as to have a CO oxidation activity substantially less than a precious metal catalyst and which consequently reduces the amount of NOx contained in the regenerator flue gas. Typically, the carbon monoxide oxidation promoter will comprise a mixture of base metal oxides which are present on a support in amounts of less than 5 wt. % of the catalyst.

### CROSS REFERENCE TO RELATED APPLICATIONS

This application claims priority to provisional application U.S. 60/742,213 filed Dec. 1, 2005.

### FIELD OF THE INVENTION

The present invention relates to a novel catalytic composition for converting CO to CO₂ while minimizing NOx emissions from a partial and a full burn fluidized catalytic cracking regenerator.

### BACKGROUND OF THE INVENTION

A major industrial problem involves the development of efficient methods for reducing the concentration of air pollutants, such as carbon monoxide, sulfur oxides and nitrogen oxides in waste gas streams from the processing and combustion of sulfur, carbon and nitrogen containing fuels. The discharge of these waste gas streams into the atmosphere is environmentally undesirable at the sulfur oxide, carbon monoxide and nitrogen oxide concentrations that are frequently encountered in conventional operations. The regeneration of cracking catalyst, which has been deactivated by coke deposits in the catalytic cracking of sulfur and nitrogen containing hydrocarbons, is a typical example of a process which can result in a waste gas stream containing relatively high levels of carbon monoxide, sulfur and nitrogen oxides.

Catalytic cracking of heavy petroleum fractions is one of the major refining operations employed in the conversion of crude petroleum oils to useful products such as the fuels utilized by internal combustion engines. In fluidized catalytic cracking (FCC) processes, high molecular weight hydrocarbon liquids and vapors are contacted with hot, finely-divided, solid catalyst particles, either in a fluidized bed reactor or in an elongated transfer line reactor, and maintained at an elevated temperature in a fluidized or dispersed state for a period of time sufficient to effect the desired degree of cracking to lower molecular weight hydrocarbons of the kind typically present in motor gasoline and distillate fuels.

In the catalytic cracking of hydrocarbons, some nonvolatile carbonaceous material or coke is deposited on the catalyst particles. Coke comprises highly condensed aromatic hydrocarbons. When the hydrocarbon feedstock contains organic sulfur and nitrogen compounds, the coke also contains sulfur and nitrogen. As coke accumulates on the cracking catalyst, the activity of the catalyst for cracking and the selectivity of the catalyst for producing gasoline blending stocks diminishes. Catalyst which has become substantially deactivated through the deposit of coke is continuously withdrawn from the reaction zone. This deactivated catalyst is conveyed to a stripping zone where volatile deposits are removed with an inert gas at elevated temperatures. The catalyst particles are then reactivated to essentially their original capabilities by substantial removal of the coke deposits in a suitable regeneration process. Regenerated catalyst is then continuously returned to the reaction zone to repeat the cycle.

Catalyst regeneration is accomplished by burning the coke deposits from the catalyst surfaces with an oxygen containing gas, such as air. The combustion of these coke deposits can be regarded, in a simplified manner, as the oxidation of CₙHₙ. The products from such combustion are water, carbon monoxide and carbon dioxide.

The waste gas stream from the combustion process is called flue gas. High residual concentrations of carbon monoxide in flue gases from regenerators have been a problem since the inception of catalytic cracking processes. The evolution of FCC has resulted in the use of increasingly high temperatures in FCC regenerators in order to achieve the required low carbon levels in the regenerated catalysts. Typically, present day regenerators now operate at temperatures in the range of about 1100° F. to 1400° F. When no CO oxidation promoter is used, the flue gases may have a CO₂/CO ratio in the range of 1-3. The oxidation of carbon monoxide is highly exothermic and can result in so-called carbon monoxide “afterburning” which can take place in the dilute catalyst phase (freeboard region), in the cyclones or in the flue gas lines. Afterburning has caused significant damage to plant equipment. On the other hand, unburned carbon monoxide in atmosphere-vented flue gases represents a loss of fuel value and is ecologically undesirable.

Restrictions on the amount of carbon monoxide which can be exhausted into the atmosphere and the process advantages resulting from more complete oxidation of carbon monoxide have stimulated several approaches to achieve complete combustion, also known as “full burn,” of carbon monoxide in the regenerator.

Among the procedures suggested for use in obtaining complete carbon monoxide combustion in an FCC regeneration have been: (1) increasing the amount of oxygen introduced into the regenerator relative to standard regeneration; and either (2) increasing the average operating temperature in the regenerator or (3) including various carbon monoxide oxidation promoters in the cracking catalyst to promote carbon monoxide burning. Various solutions have also been suggested for the problem of afterburning of carbon monoxide, such as addition of extraneous combustibles or use of water or heat-accepting solids to absorb the heat of combustion of carbon monoxide.

Specific examples of treatments applied to regeneration operated in the complete combustion mode include the addition of a CO combustion promoter metal to the catalyst or to the regenerator. The use of precious metals to catalyze oxidation of carbon monoxide in the regenerators of FCC units has gained broad commercial acceptance. Some of the history of this development is set forth in U.S. Pat. No. 4,171,286 and U.S. Pat. No. 4,222,856. In the earlier stages of the development, the precious metal was deposited on the particles of cracking catalyst. Present practice is generally to supply a promoter in the form of solid fluidizable particles containing a precious metal, such particles being physically separate from the particles of cracking catalyst. The precious metal, or compound thereof, is supported on particles of suitable support carrier material and the promoter particles are usually introduced into the regenerator separately from the particles of cracking catalyst. The particles of promoter are not removed from the system as fines and are cocirculated with cracking catalyst particles during the cracking/stripping/regeneration cycles.

Promoter products used on a commercial basis in FCC units include a support carrier material of calcined spray dried porous microspheres of kaolin clay impregnated with a small amount (e.g., 100 to 1500 ppm) of platinum. Most commercially used promoters are obtained by impregnating a source of platinum on microspheres of high purity porous alumina, typically transition alumina. The selection of platinum as the precious metal in various commercial products appears to reflect a preference for this metal that is consistent with prior art disclosures that platinum is the most effective group VIII metal for carbon monoxide oxidation promotion in FCC regenerators.

Judgment of the CO combustion efficiency of a promoter is done by the ability to control the difference in temperature, ΔT, between the (hotter) dilute phase, cyclones or flue gas line, and the (cooler) dense phase. Most FCC units had used a Pt CO combustion promoter, but very recently non-Pt promoters, mainly based on Pd, have seen wider use.

U.S. Pat. No. 4,608,357 teaches that palladium is unusually effective in promoting the oxidation of carbon monoxide to carbon dioxide under conditions such as those that prevail in the regenerators of FCC units when the palladium is supported on particles of a specific form of silica-alumina, namely leached mullite. The palladium may be the sole catalytically active metal component of the promoter or it may be mixed with other metals such as platinum.

Much of the art and apparently all of the commercial trials undertaken for EPA consent decrees and the like have focused on precious metals for the development of low NOx CO promoters. In practice then, precious metals are the materials being used in the industry. CO oxidation by non precious metal catalysts is known, however, and their use is found for FCC regeneration in the patent literature. The object of those works in general was the maximization of CO conversion activity per unit weight of active metals and/or additive, in order to better compete with the high activity precious metal promoters. Historically, the main driving force in choosing a CO promoter has been the convenience and cost thereof to the refiner, although NOx emissions have become more important of late.

While the use of combustion promoters, such as platinum, reduces CO emissions, such reduction in CO emissions is usually accompanied by an undesirable effect, an increase in nitrogen oxides (NOx) in the regenerator flue gas. It has been reported that the use of prior art CO promoters can cause a dramatic increase (e.g. >300%) in NOx. It is difficult in a catalyst regenerator to completely burn coke and CO without increasing the NOx content of the regenerator flue gas. Since the discharge of nitrogen oxides into the atmosphere is environmentally undesirable and strictly regulated, the use of these promoters has the effect of substituting one undesirable emission for another. In response to environmental concerns, much effort has been spent on finding ways to reduce NOx emissions while maintaining control over afterburn and flue gas CO concentration.

Various approaches have been used to either reduce the formation of NOx or to treat the NOx after formation. Most typically, additives have been used either as an integral part of the FCC catalyst particles or as separate particles in admixture with the FCC catalyst.

Various additives have been developed that claim CO promotion while controlling NOx emissions.

U.S. Pat. Nos. 4,350,614, 4,072,600 and 4,088,568 disclose rare earth addition to Pt based CO promoters. An example is 4% REO that shows some advantage. There is no teaching of any effect of REO on decreasing NOx emissions from the FCC.

U.S. Pat. No. 4,199,435 teaches a combustion promoter selected from Pt, Pd, Ir, Os, Ru, Rh, Re and copper on an inorganic support.

U.S. Pat. No. 4,290,878 teaches a Pt—Ir and Pt—Rh bimetallic promoter that reduces NOx compared to a conventional Pt promoter.

U.S. Pat. No. 4,300,997 teaches the use of a Pd—Ru promoter for oxidation of CO that does not cause excessive NOx formation.

U.S. Pat. No. 4,544,645 describes a bimetallic of Pd with every other Group VIII metal but Ru.

U.S. Pat. Nos. 6,165,933 and 6,358,881 describe compositions comprising a component containing (i) an acidic oxide support, (ii) an alkali metal and/or alkaline earth metal or mixtures thereof, (iii) a transition metal oxide having oxygen storage capability, and (iv) palladium; to promote CO combustion in FCC processes while minimizing the formation of NOx.

U.S. Pat. No. 6,117,813 teaches a CO promoter consisting of a Group VIII transition metal oxide, Group IIIB transition metal oxide and Group IIA metal oxide.

As opposed to complete CO combustion, FCC catalyst regenerators may be operated in an incomplete mode of combustion, and these are commonly called “partial burn” units. Incomplete CO combustion leaves a relatively large amount of coke on the regenerated catalyst which is passed from an FCC regeneration zone to an FCC reaction zone. The relative content of CO in the regenerator flue gas is relatively high, i.e., about 1 to 10 volume percent. A key feature of partial combustion mode FCC is that the heat effect of coke burning per weight of coke is reduced because the exothermic CO combustion reaction is suppressed. This enables higher throughput of oil and lower regenerator temperatures, and preservation of these benefits is essential to the economics of the FCC process. Under incomplete combustion operation NOx may not be observed in the regenerator flue gas, but sizable amounts of ammonia and HCN are normally present in the flue gas.

While the prior art has focused on the additives' impact to the formation of NOx in a full burn operations, these known additives are becoming increasingly inadequate when much lower emission standards are developed. Further, these additives have not been demonstrated to be effective in a partial burn operation. Partial bum operations minimize the conversion to CO to CO₂, but as above stated are characterized by the presence of HCN and NH₃ in the flue gas. The chemistry of partial burn shows that HCN and NH₃ are intermediates in the formation of N₂ and NOx. Most FCC operations use CO promoters however, whether operating in intermediate partial bum or full burn. The problem in the art has been however that the use of known CO promoters simultaneously converts HCN and NH₃ to NOx, increasing NOx emissions in partial burn operations.

Most, if not all of the CO promoters from the major manufacturers that are in use today are based on precious metals. Pd is preferred most recently in order to reduce selectivity to NOx. Research into precious metal promoters continues (U.S. Pat. No. 6,358,881; or US 2004/0074809 A1). While less common in practice, there is still significant prior art in the field of base metal catalysts for CO oxidation in general, as well as in FCC in particular.

Engine exhaust catalysts require precious metals in order to be competitive in the marketplace. Still significant research has been done seeking base metal formulations to replace them, in order to reduce costs. Voorhoeve et al. (Science 177 354, Jul. 28, 1972) showed lanthanum cobaltite and praseodymium cobaltite having the perovskite structure were active catalysts for CO oxidation, and could catalytically reduce NOx to N₂ (and N₂O) when mixed with CO, H₂ and H₂O. They suggested the catalysts may be useful for exhaust gas purification.

Whelan in U.S. Pat. No. 3,885,020, claimed rare earth and transition metal perovskite catalysts modified with Zr, Sn, or Th, and optionally an alkaline earth, as being effective for a large number of reactions, including those among combustion products and NOx-related compounds. The theory of perovskites is elaborate but their use in FCC is not disclosed. U.S. Pat. No. 3,897,367 provides a more useful discussion of the perovskite theories. The application of perovskites in the patent is directed to cleanup of exhaust gases, engine exhaust in particular, but not FCC. The materials also contain precious metals. U.S. Pat. No. 5,093,301 discloses La—Sr—Fe—Cu—Mn perovskites with at least one layer for general combustion applications. FCC is not mentioned. The catalysts may also include a layer of mixtures of the same metals as oxides, now in the spinel structure A₁B₂O₄. Cu₁Fe₂O4, and FeMn₂O₄ spinels in conjunction with perovskite are thus known CO oxidation catalysts but the pore size is asserted to be such that mass transfer is not limiting.

In U.S. Pat. No. 4,102,777, Wheelock discloses the preparation of a “high surface area perovskite catalyst” by first preparing a spinel-coated support material and then impregnating perovskite precursor salts and calcining at 600-1000° F. La, Fe, Mn, and Cu are employed but silicon is excluded as a support or dopant. Wheelock discloses in U.S. Pat. No. 4,446,011 the use of perovskites in FCC to aid the combustion of coke. The perovskite may be used as an unsupported or supported additive, or it may be incorporated into the main FCC catalyst. The preferred material is barium zirconate or hafnate. Between 0.1 wt % and 20 wt % of perovskite in the FCC catalyst blend is claimed. The object of the invention is to increase the rate of coke combustion using the perovskite and while one example showed increased CO₂/CO in regeneration, NOx results were not disclosed and NOx was not discussed in the patent.

Gladrow in U.S. Pat. No. 4,208,269 describes a cracking catalyst comprising 3-20% zeolite, an inorganic oxide gel and, broadly, 0.5-10 wt % perovskite that contains at least one transition metal, and associated hydrocarbon processing. LaCoO₃ is a preferred perovskite with 1.5-4% perovskite preferred. The inventors were surprised to find that CO was effectively promoted to CO₂, but NOx was not mentioned in the patent.

Vasalos in U.S. Pat. No. 4,440,632 reduces SOx emissions by adding O₂ to the FCC spent catalyst stripper, which somewhat preferentially burns the S in coke over C in coke. The detailed description allows that a water-gas shift catalyst might optionally be included in the process to facilitate reduction of the SO₂, made in the selective S burning in the stripper, to H₂S to exit from the riser side. The precise nature of the shift catalyst metals was said not to be critical but 0.01-10 wt % could be included, either dispersed throughout the FCC catalyst or present as a separate additive. Suitable shift catalysts listed were Fe₂O₃ and CuO, among many others, and mixtures thereof. Many supports are offered. Regeneration of coked catalyst was done but CO₂/CO was not reported and NOx was not mentioned in the patent.

Dieckmann et al. (U.S. Pat. Nos. 5,364,517; 5,565,181) disclose FCC NOx reduction additives based on spinel/perovskite structures which were proposed to maintain activity and be sulfur-tolerant. The perovskite contains at least one transition metal and a preferred embodiment is Ln—Cu—Mn—Fe perovskites at 1-40%, preferably 10-30% loading in the additive itself. Examples are at about 15% or 25% loading. The additive also comprises a Group IIA/IIIA spinel, exemplified by MgAl₂O₄, and an optional stabilizer such as copper. The patent offers that this additive may be used as a separate microsphere or alternatively dispersed throughout the FCC catalyst. However, there is no theorizing, explanation, or preference given in the patent as to a special use or advantage in NOx results for dispersing the additive throughout the FCC catalyst or preparing additives at low loadings and CO promotion activities. The additives are also deemed compatible with CO oxidation promoters, which can be taken to mean precious metals maintained at or below 1 ppm (essentially a full dose).

Tang and Lin (U.S. Pat. Nos. 5,242,881; 5,443,807) claim further improvement in CO oxidation activity and stability when using mullite as a support in FCC regeneration. An example shows that NOx is coincidentally reduced vs. a standard 500 ppm Pt CO promoter, however the main focus of the patent is on achieving CO conversion activity comparable or greater than the typical Pt promoter, in order to reduce costs. 5-20% loading of the perovskite on the mullite-supported additive is used to accomplish the high activity and stability. No indication is given that this may be harmful for NOx selectivity.

McCauley (U.S. Pat. No. 6,117,813) attempts to solve the same problems of activity and cost with a mixed metal oxide system exemplified by La—Sr—Co oxide while using an alumina support other than mullite. No guidance is provided on the phases, component ratios, or loading, but an example and a claim suggest 8-10 wt % of metal oxide. The main point of the patent is making high activity base metal CO promoters that can compete with precious metal promoters such as 500 ppm Pt/Al₂O₃.

Lin et al. (U.S. Pat. No. 6,596,249) disclose a non-precious metal promoter based on Cu—Al and Ce—Al complex oxides on an alumina support. The loading of these two complex oxides yields a promoter with high catalytic activity and stability, comparable to 500 ppm Pt on alumina. Pilot plant testing apparently showed 50% reduction in NOx.

Yoo et al. (U.S. Pat. No. 4,790,982) claim a metal-containing spinel (for SO₃ absorption) in combination with a third and fourth metal (for SOx oxidation and reduction) to be used as a SOx additive in FCC. The patent recites many mixed metal oxides having a spinel structure, including CuFe₂O₄, MnFe₂O₄, NiFe₂O₄, and Fe^{II}Fe^{III}₂O₄. These spinel oxides are to be used at high loadings and generally function as the support. NOx reduction has sometimes been asserted for the most preferred version of this technology (Ce/V/MgAl₂O₄) but use of these spinels as low NOx CO oxidation promoters is not discussed in these patents.

Thus the use of base metal CO oxidation promoters, especially perovskites, is known in FCC. Some of the formulations do report improvements in NOx selectivity, and indeed such may be possible through optimization of the formulations and their catalytic chemistry, even if they operate with overheating. None of the found art discloses the concept that either the precious or base metal promoters may be diffusion-limited and heat transfer-limited, and that there could be consequences for NOx selectivity. Therefore none of this art is enabling of a low activity base metal CO promoter which is not heat transfer limited, and therefore operates at temperatures closer to the average temperature of the regenerator dense bed. Cooler CO promoter microspheres will operate with the deficit of lower intrisic CO oxidation rate, however the same hypothetically cooler operation has reduced NOx selectivity as an unexpected benefit.

It is an object of the invention to convert CO to CO₂ while minimizing the parallel oxidation of HCN and NH₃ (NOx precursors) to NOx in full burn or intermediate partial burn FCC regenerators, in the presence of SOx and steam.

It is an object of the invention to fully replace and eliminate the need for precious metal CO promoter in an FCC unit, in order to avoid their high yields of NOx. It is an object of the invention to maximize the conversion of NOx and NOx precursors to N₂ within the dense bed during full burn or intermediate partial bum FCC regeneration.

### SUMMARY OF THE INVENTION

This invention describes mixed base metal CO oxidation promoters for FCC which minimize coincidental HCN and NH₃ oxidation to NOx, and reduce NOx already present to N₂. Examples are mixed base metal oxides previously known as water-gas shift or CO oxidation catalysts, and to some degree as CO promoters in FCC. The improvement herein is the preparation of the base metal CO promoters at low loadings on a support or incorporation into an FCC catalyst, such that the promoter activity per unit weight of additive is less than about 10% of the activity of the standard 500 ppm Pt/Al₂O₃CO promoter used under FCC conditions. The low activity is believed to relieve a mass and heat transfer limitation which hypothetically allows the microspheres to operate at cooler temperatures, closer to the average bed temperature. Prior art promoters have such high activity that they apparently overheat in use, increasing the NOx selectivity in the case of non-precious metal promoters. Pt promoter made at low loading shows little or no improvement in selectivity under cooler operation however, so low activity precious metal promoters are not within the scope of the invention.

Base metal CO promoters having high activity also result in a selectivity to NOx that is not significantly improved as compared to precious metal promoters. Surprisingly, however, it has been discovered that if these same base metal promoters are prepared at low concentration, their selectivity to NOx at constant CO conversion is dramatically reduced. It is theorized that the optimization of CO conversion activity per unit base metal was historically so successful that the resulting promoters were also overheating in use, due to heat and mass transfer limitations, and that this overheating had degraded their selectivity and increased NOx. Since the base metal CO oxidation catalysts have been known for more than thirty years, it can be concluded that the art had apparently not considered this limitation that results due to high activity.

### BRIEF DESCRIPTION OF THE DRAWINGS

FIG. 1 is a graph of the temperature effect on free energy of Mars-van Krevelen oxidation of NH₃ to NOx wherein the key illustrates the oxidation state of the metals before and after oxidation.

FIG. 2 is a graph of the CO₂, CO, and O₂ species of a simulated regenerator reactor feed bypassed directly into an analyzer without reaction utilizing a lambda sweep in which the feed transitions between a fuel-rich and fuel-lean state.

FIG. 3 is a graph of nitrogen species of a simulated regenerator reactor feed bypassed directly into an analyzer without reaction utilizing a lambda sweep in which the feed transitions between fuel-rich and fuel-lean states.

FIG. 4 is a plot of lean side NOx formation for comparative precious metal catalysts and base metal oxidation catalysts at high and low loadings as described in Example 4.

FIG. 5 is a plot of the performance for removing NOx using base metal oxide catalysts at various loadings as described in Example 4.

FIG. 6 is a bar chart showing the nitrogen compound yields and CO2/CO ratio found using unpromoted catalysts and various promoted catalysts in accordance with the invention as described in Example 5.

FIGS. 7A, B and C illustrate the formation of NOx and N2, respectively for various catalysts over three lambda cycles in which the feed transitions between fuel-rich and fuel-lean for each lambda cycle and as described in Example 5.

FIG. 8 is a bar chart showing the integrated overall nitrogen compound yields together with a CO2/CO ratio in a run of a lambda sweep using various comparative and inventive oxidation promoters and as described in Example 6.

FIG. 9 shows the CO2/CO curves found during the lambda sweep comparing various oxidation promoters as described in Example 6.

FIGS. 10A, 10B, and 10C are plots of the transient response of N₂, NOx, and NH₃ respectively during a lambda sweep using various oxidation promoters and as described in Example 6.

FIG. 11 is a plot comparing the lean side NOx production of various CO oxidation promoters having a constant CO oxidation activity and as described in Example 7.

FIG. 12 is a bar chart showing the impact on nitrogen species found at running the regenerator at various oxygen conversions and as described in Example 8.

FIGS. 13A-13D are graphs illustrating the transient levels of CO₂, CO, O₂, N₂, and NOx over three lambda cycles under varying simulated oxygen conversions in the regenerator and as described in Example 8.

FIG. 14 is a plot of total NOx yield of a comparative precious metal CO oxidation catalyst and two CO oxidation catalysts of the present invention relative to CO₂/CO and as described in Example 9.

FIG. 15 is a schematic design of a regenerator illustrating particle flow therein.

FIG. 16 is a schematic design of the testing apparatus used to run the lambda sweep testing as described in the Examples.

### DESCRIPTION OF THE INVENTION

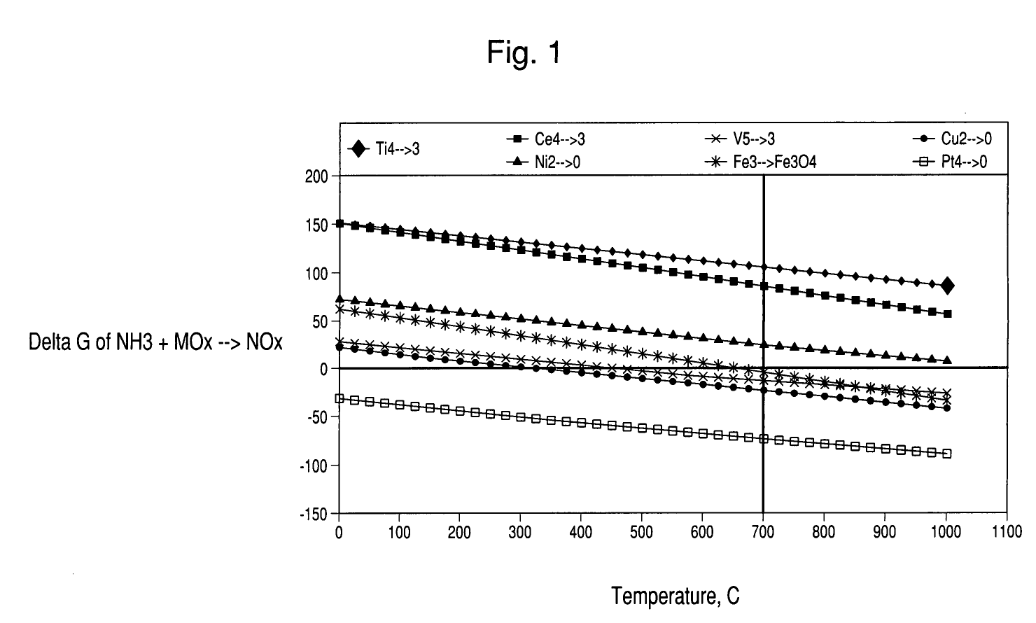

Without wishing to be bound by any theory, an approximate model for NH₃ oxidation is now proposed based on the Mars-van Krevelen selective oxidation mechanism. This known mechanism postulates that bulk lattice oxygen is the source of the oxidizer in these reactions. We theorize that an analogy can be drawn between the stoichiometric reaction of NH₃ with a metal oxide at 1300° F. and the selective catalytic oxidation. If the Gibbs free energy of the stoichiometric reaction to make N₂ is negative, the catalytic reaction to N₂ may hypothetically proceed at a reasonable pace. If the Gibbs free energy of the stoichiometric reaction to make NOx is also negative, the catalytic reaction to NOx might also proceed, potentially increasing selectivity to NOx. We have estimated the Gibbs free energy as a function of temperature, finding that platinum oxide is able to produce NOx from NH₃ by stoichiometric reaction at all reasonable temperatures. The base metals on the other hand have smaller negative, near zero, or even positive free energy values, suggesting NOx is hypothetically less likely by catalytic reaction. This is illustrated in the FIG. 1. Also evident from FIG. 1 is that the likelihood of making NOx by the stoichiometric reaction increases with increasing temperature. While one extrapolates this to catalysis only with caution, as the calculations do produce anomalies, the general trend may serve as a guide which implies a degradation of NH₃ oxidation selectivity to NOx might be encountered with increasing temperature. Therefore, we assert that it was heretofore unexpected and surprising that diluting the activity of CO promoters prepared with only base metals advantageously reduced selectivity to NOx, while at the same time precious metal promoters would not be measurably affected.

Dramatically improved selectivity is obtained for the selective oxidation of NH₃ and HCN to N₂ on the present materials: 60-70% lower lean side selectivity to NOx is obtained than for the precious metals which are commonly employed for regenerator CO oxidation. CO activity per unit weight of active metals is indeed much less than for the precious metals. However the surprising result has been discovered that the precious metals are so active that they appear to be heat transfer limited and mass transfer limited within the pores of the promoters when tested fresh at regenerator conditions. Typically the precious metal promoters contain 300-500 ppm of Pt or Pd.

The base metal materials used in the mixed oxide promoter of this invention include the transition metals of the periodic table of elements except for the precious metals. Certain transition metals may not be preferred due to the toxicity thereof. Useful mixed base metal materials including the Fe₂Cu₁ and Mn₂Cu₁ based recipes described below, have exceptionally high activity and selectivity for the conversion of NH₃, HCN and NOx to N₂ under the both fuel-rich, net reducing gas environment, and fuel-lean, net oxidizing conditions. Prior art materials, including the precious metals on Ce-containing supports, have had much higher conversion and yields to NOx on the lean side. This is significant because the full burn regenerators that are the larger portion of the market and the chief users of CO promoter contain mainly, if not exclusively, fuel-lean conditions. Lean side NOx had been difficult to reduce in the past. Surprisingly, the N₂ selectivity of the inventive materials actually improves as conditions become more and more lean.

Briefly, base metal CO oxidation promoters for FCC are disclosed which minimize coincidental HCN and NH₃ oxidation to NOx, and reduce NOx already present to N₂. The mixed base metal oxides have previously been known as water-gas shift or CO oxidation catalysts (and to some degree as CO promoters in FCC). The improvement in this invention is the preparation at low mixed metal oxide loadings and activities. The mixed metal oxides are loaded on a support or incorporated into an FCC catalyst, such that the activity for CO oxidation per unit weight of additive is less than about 10%, preferably, less than 1% of the activity of the standard 500 ppm Pt/Al₂O₃ CO promoter used under FCC conditions. The promoter additive of this invention should have a CO oxidation activity of at least 0.2%, preferably at least 0.5% of the activity of the standard 500 ppm Pt/Al₂O₃ CO oxidation promoter. While other interpretations are possible, the lower activity is believed to relieve a mass and heat transfer limitation which hypothetically allows the microspheres to operate at cooler temperatures, closer to the average bed temperature. Prior art promoters have such high activity that such promoters apparently overheat in use, increasing the selectivity to NOx in the case of non-precious metal promoters. Pt promoters made at low loading show little or no reduction in selectivity to NOx under cooler operation, however, so low activity precious metal promoters are not within the scope of the invention.

In a preferred embodiment, the base metal promoters of this invention are pre-blended with high activity cracking catalyst, particularly the catalyst described in commonly assigned, U.S. Pat. No. 6,656,347. Preferably the mixture is used as an additive, so that the cracking activity of the FCC catalyst inventory is not diluted excessively and any FCC unit may benefit by this technology, regardless of the origin of the main FCC catalyst supply.

Typical CO oxidation promoter formulations of this invention will contain less than 5 wt %, typically less than about 3 wt % and are further exemplified by up to about 1 or 2 wt % loading of base metal as oxides. Non-limiting examples of mixed base metal oxides include Fe₂Cu₁O₄ or Mn₂Cu₂O₄, possibly containing promoters of Ni, La, alkaline earth, rare earth, etc., on an alumina support. Other metal oxide supports can be used and are well known in the art. Non-limiting examples of useful base metal oxide formulations are provided in the Examples below.

In general, it is proposed that any good catalyst devoid of precious metals and that was previously known as a water-gas shift “WGS” or CO oxidation catalyst or promoter at temperatures over 500° C. preferably above 600° C. and does not derive a significant amount of its activity from Cu°, Cu₂O or CuO can be used. Importantly, effective catalysts when made as a FCC CO promoter, should have an activity for CO oxidation measured at FCC regenerator conditions of temperature at least 1100° F. of less than about 10 times, preferably less than 100 times lower than a 500 ppm Pt/Al₂O₃ to reduce NOx production. The invention is not directed to any specific combination of metal oxide or oxides combined in any special ratio or phases to form a WGS or CO oxidation catalyst. Moreover, neither the support that the oxides are deposited on or blended with, nor the process to make these catalysts, are critical to the invention. The use of the proposed catalyst in FCC as a low NOx promoter appears to be novel so long as the activity of the promoter for CO oxidation is sufficiently low.

There has been much attention focused on mixed metal perovskites as oxidation catalysts, as is noted in the section on prior art alone. This art extends back thirty years. LaCoO₃ in particular was identified early. Since then other materials containing La, Co, Cu, Fe, Mn, Ni, Sr, Ca and other elements, as well as specific combinations of elements to generate structural vacancies, have been claimed as effective. Tang and Lin (U.S. Pat. Nos. 5,242,881; 5,443,807) claim further improvement in CO oxidation activity and stability when using mullite as a support in FCC regeneration. However, the patentees overlooked the essential low activity and low loading aspect of the present invention.

Some of the art on perovskites has called for the addition of precious metals to those catalysts. It is believed that precious metals should be excluded for best results. For the purpose of the present invention, precious metal is defined as Ru, Rh, Pd, Ag, Os, Ir, and Pt. The exclusion should apply whether the base metal oxide catalyst of this invention is a perovskite or any other structure. Of course at sufficiently low loading, trace amounts, e.g. less than 75 ppm or less than 5 ppm and even less than 1 ppm of precious metal may be immaterial.

Also excluded are catalysts deriving a substantial amount of their activity from pure copper or its oxides. Testing of CuO on alumina or Cu/Al₂O₃ has been found to lead to NOx on the lean side during catalyst regeneration, and the Gibbs free energy allows for CuO making NOx from NH₃. Still, copper is a mainstay of the prior art for NOx additives. Copper in combination with certain other oxides, Fe and Mn in particular, and other base metal oxides other than ceria in general, has been found quite favorable however. This is surprising and we are not able to predict such outcomes. It is speculated however, based on the selective oxidation literature, that the Cu—O—M bonds present in mixed copper-base metal (M) oxides are of a strength, and the oxygen atoms are of an activity more effective for N₂ formation or unsuitable for NOx formation. Based on this speculation, it is prefered that copper be combined with other metal oxides to form stable mixed metal oxide phases under regenerator conditions, rather than forming phase-segregated copper oxide and the like. It is not presently known which base metals are best to mix with Cu. Levels of copper oxides should be less than 40 wt % of the mixed base metal oxide formulations.

The recipes that have been explored experimentally have been derived from known water-gas shift catalysts. Because hydrogen oxidation is facile, we reasoned that the sum of the reactions CO+H₂O=CO₂+H₂ and H₂+O₂=H₂O was CO+O₂=CO₂, so that water could be a co-catalyst for CO oxidation by water-gas shift catalysts. High temperature shift catalysts containing only base metals were hypothesized then to be active low NOx promoters. K. Kochloefl in “Handbook of Heterogeneous Catalysis” Ertl, G. Knozinger, H., and Weitkamp, J., Eds., (1997), cites chromium-free formulations based on Co—Mn, Cu—Mn, Fe—Mn promoted with alkali. Chromium is not a preferred component because of environmental and health issues. We have formulated such catalysts and found them generally to be active for CO conversion to CO₂ under regenerator conditions, although they are much less active than precious metals. In contrast to the prior art, this result is now viewed as being favorable.

It is now believed that the WGS reaction on high temperature Fe—Cr catalyst occurs by an oxidation-reduction mechanism similar to the Mars-van Krevelen mechanism for selective oxidation. Based on our confirmation that high temperature WGS catalysts are active for CO conversion in the regenerator, we can now take the prior art on high temperature water-gas shift catalysts as instructive on the preparation of high activity (per unit mixed metal oxide) CO promoters for FCC. The scope of the present invention then encompasses the teachings of the high temperature WGS (“HT WGS”) art for FCC promoters, the improvement of which is the constraint that the activity thereof be no higher than about 10%, preferably no higher than about 1% of the activity per weight of additive of a 500 ppm Pt reference standard (USP-500) tested at regenerator conditions, e.g. at least 1100° F.

The NOx selectivity is not always successfully predicted by the Gibbs free energy analogy. Mn and Cu are both strong oxidizers for which one might anticipate increased selectivity to NOx as individual components. While increased selectivity to NOx with CuO individually is found, Mn₈Cu₄ on alumina has greatly reduced selectivity to NOx when prepared at about 2 wt % or less loading. Thus the performance of mixtures is not predictable. HT WGS catalysts prepared at about 2 wt % mixed metal oxide loading or lower have all had good reduced selectivity to NOx, but it remains possible that at least some of the known HT WGS art will produce CO promoters for FCC with higher NOx selectivity, even if they are prepared at sufficiently low activity.

Non-limiting examples of useful catalysts of the invention can further be found in Example 4 below. The best samples are those giving a high CO₂/CO ratio while at the same time having a low NOx-Log(CO₂/CO) slope, i.e., low NOx forming selectivity. 1% Fe₆Cu₂Mn₂La₂O_{x,} 0.5% Fe₈Cu_{4,} 0.5-2% Mn₈Cu₄, and 1% Mn₈Cu₃Ni₁ are particularly attractive. The samples in Table 2 were derived from the most promising of the samples at high loading in Example 3. It is therefore possible that there are formulations in Example 3 which would be very successful if made at low loading. Similarly promising formulations may also be derived from the WGS or perovskite prior art which have not yet been investigated.

The successful samples of Example 4 were all prepared on a Puralox alumina support. Other supports may be useful, for example, Si-modified Puralox support, mullite and calcined kaolin supports. The preferred support is microspheroidal alumina.

Puralox alumina support is a microspheroidal material containing only transition aluminas. It may be speculated that an effective replacement could be made by spray drying granular or peptized alumina with a binder such as colloidal silica, silica-alumina, alumina, aluminum chlorohydrol, and the like, potentially diluted with kaolin or other filler. Reducing the cost of the support will be valuable since large volumes of the promoter may be needed.

In general, successful FCC CO promoters should have the physical properties typical of other FCC catalysts and additives. Such specifications are well known, but in summary, their average particle size should be about 50-150 mm, typically about 70-85 um, fall bulk density between about 0.7 and 1.1 g/cc, and their attrition resistance should be comparable to the noted standards by any one of several attrition tests.

In the event that dilution of the promoter is sought by spray drying with filler to form microspheres, it may be advantageous to pre-deposit the metal oxides onto the granular alumina or other catalyst support before the formation of the microsphere. This may lead to improved activity and stability. This is within the scope of the invention.

Deposition of the active metal oxides upon the support can be carried out by any known means, especially methods known to prepare successful WGS catalysts. Dissolution of metal nitrate salts into water, followed by impregnation, drying and calcination is preferred for the WGS catalyst preparations. Deposition-precipitation is another very suitable means for WGS catalyst preparation. Calcination under oxygen or air at temperatures of at least 800° F. converts the metal salts to oxides. Calcination in open trays at 1400° F. for two hours has been found useful.

There is significant prior art on the preparation of the perovskite oxidation catalysts. In most early cases the perovskite is prepared by ball milling the pure oxides, carbonates or hydroxides together, followed by calcination at elevated temperatures, typically at least 600° C. Later preparations were often done by coprecipitation of mixed hydrogels, followed by calcination to make unsupported perovskite. Most recently, pre-formed supports have been impregnated with mixed salt solutions, dried and calcined. This last procedure using a mullite support is most attractive, except that the material should be prepared with sufficiently low CO oxidation activity so as to obtain lower NOx formation selectivity.

Whelan (U.S. Pat. No. 3,885,020) and others provide theories of rare earth and transition metal perovskite catalyst operation which may be useful in the optimization of performance. Structural vacancies are thought to improve oxygen ion conductivity, and these can be further modified by using metal atoms with specific diameters. This leads to long lists such as Zr, Sn, or Th, alkaline earths, as well as transition metals being employed. It is not the specific combination of elements in the perovskite or other structure that forms the basis of the invention however. The invention is that these known base metal oxide combinations and structures be employed to form a CO promoter of less than a specified CO promotion activity.

The exact limits of promoter activity or active metal loading have not yet been determined for the most favorable operation. The fundamental parameters governing the overheating process that is speculated to be the origin of the improvement are the diameter of the promoter microsphere, the kinetic rate constant per unit weight of the promoter microspheres, the diffusivity of CO and O₂ inside the microsphere, the thermal diffusivity inside the catalyst and the heat transfer coefficient outside the catalyst, and the heat of reaction. The particle diameter is constrained by the specifications for FCC catalysts. There is comparatively little flexibility in the diffusivity at process conditions, although, minor improvements can be made by altering pore size distribution under the constraint of attrition resistance. As a practical matter, that leaves the kinetic rate constant per unit weight of promoter microspheres as the sole way to influence the overheating problem. Reducing the rate constant per unit weight of the additive can be done by making an additive at lower active metal loading or by using a less active formulation at constant loading.

A few tests with Pt promoter showed that 80 ppm Pt had higher activity per unit Pt than 8 ppm or 800 ppm Pt. This suggests that the effectiveness factor for 80 ppm Pt was greater than one and the microsphere was overheating. The effectiveness factor for the 8 ppm Pt is suspected to be unity, so that the catalyst is not overheating.

The 800 ppm Pt sample had activity per unit Pt similar to the 8 ppm Pt, due to the canceling out of the mass transfer limit with the kinetic impact of overheating, and an effectiveness factor near unity. This leads to the approximate specification that CO promoters for FCC should have kinetic rate constants per unit weight of promoter microspheres that are about less than 10%, and even less than 1% of the activity of a Pt promoter with 500-800 ppm Pt on alumina. It is essential under the hypotheses we are operating with to have some limit on the activity, even if the exact definition has not yet been determined.

The precise rate constants need not be determined to apply the activity constraint. Thus, the CO oxidation additive must be employed in amounts of at least 10, preferably in amounts of at least about 100 times the dose in the FCC catalyst as a 500 ppm Pt/Al₂O₃ promoter in order to obtain the same or comparable CO conversion or CO₂/CO ratio. Both additives are to be compared on a fresh activity basis. This specification leads to base metal oxide promoter doses of the order of about 1-50 wt % in the FCC catalyst inventory. Doses as much as 20 wt %, and preferably 5-10 wt. % can be used. For 10% dose of additive having 1 wt % loading of base metal oxides, the equilibrium catalyst will have about 1000 ppm of base metal oxides added via the promoter.

If 10 wt % CO promoter dose in the FCC catalyst inventory must be used to minimize NOx selectivity, it brings with it a challenge to reduce the cost of the support. Less expensive promoters can be made by pre-depositing the active base metal oxides onto alumina, and the alumina spray dried with kaolin, optionally with a binder, and calcined to form a low cost, low activity promoter. The same flow plan could be followed to make an FCC catalyst or additive containing zeolite and other cracking catalyst ingredients. Lastly, it may be possible to blend the metal salt solutions with colloidal alumina and co-impregnating an inexpensive support such as kaolin microspheres or FCC catalyst, the alumina stabilizing the metal oxides better than the support alone. Pre-impregnating kaolin microspheres with alumina sol is particularly attractive.

Standard reaction engineering practice instructs that in the case where diffusion and heat transfer limitations are present, the impact on conversion and selectivity must be measured at the actual process conditions. Testing at a lower temperature for example risks relieving these limitations, potentially leading to incorrect conclusions. It is therefore essential that comparative testing be done at a representative regenerator temperature. We have used 1300° F., but temperatures ranging from 1200-1400° F. may be appropriate for analysis of specific FCC units. If an FCC unit is operating at a lower regenerator temperature, the impact of the overheating effect will be less, and a higher activity base metal oxide low NOx promoter could be employed. On the other hand, if a unit has a hotter regenerator, the overheating problem will be more severe and even lower metal oxide loading may be required to improve selectivity. Because there is a systematic effect of temperature on the Gibbs free energy of the stoichiometric reaction to form NOx, it can be speculated that higher regenerator temperatures may also require a change in promoter formulation. The NOx selectivity of a given metal oxide formulation at 1350° F. may not be suitable, even if such formation is suitable at 1300° F.

1000 ppm of base metal oxide added to an FCC catalyst should be expected to have an impact on coke and H₂ yields on the riser side. Preferred formulations will have higher CO promotion activity per unit metal oxide, in order that the coke and H2 yield impacts can be minimized. If such higher activity mixed metal oxides are employed, this should not lead to one increasing the activity per unit weight of promoter beyond the claimed limits, as this will increase NOx. Instead, the benefit of the higher specific activity of the mixed base metals is to be taken as a reduced base metal oxide loading on the additive itself, with the same additive dose being used in the FCC catalyst inventory. Finally, it is worth noting that long catalyst contact time tests such as the MAT or FFB exaggerate the activity of metals to produce H₂ and contaminant coke. Circulating pilot plant results will be more representative of commercial impacts.

### EXAMPLES

The CO combustion promoters of this invention and comparative promoters were tested by a method described in provisional applications U.S. Pat. No. 60/741,331 filed Dec. 1, 2005 and U.S. Pat. No. 60/782,501 filed Mar. 15, 2006 and U.S. Ser. No. ( Docket 5187B) filed, the entire contents of which are herein incorporated by reference. In general, in the method described in the above applications the promoters are contacted with test gasses and air which are fed in a varing air/fuel profile over time that is characterized as a lambda sweep. The combustion products are measured during the varying conditions.

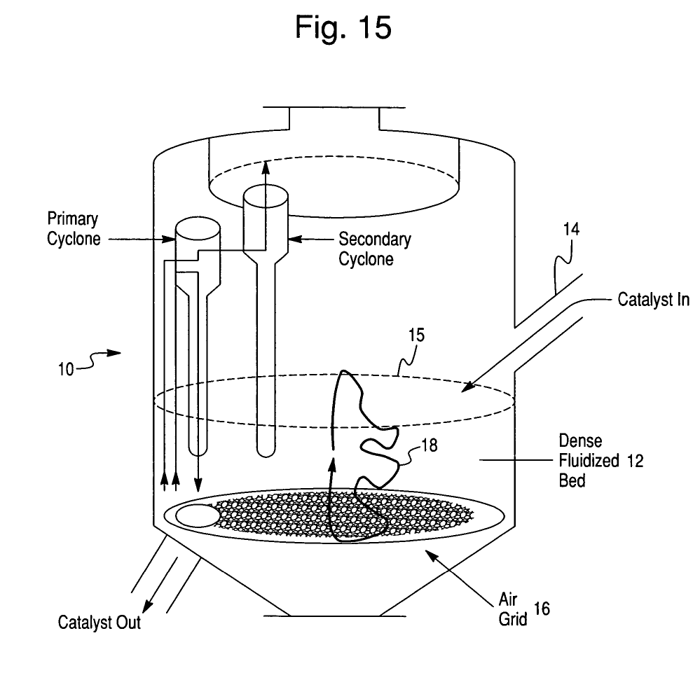

The basis of the test is found in the flow of particles and gases in an FCC regenerator. FIG. 15 represents an FCC regenerator and the flow of particles therein. Reference numeral 10 represents an FCC regenerator. In practice, spent coked catalyst is discharged into the regenerator fluidized bed 12, sometimes at the edge of the vessel 10 with tangential entry such as shown by inlet 14, and sometimes towards the center of bed 12 with devices able to disperse the material more evenly over the bed. Generally, air is introduced through a grid 16 near the bottom of the bed 12. The grid 16 supplies oxygen to burn the coke on the catalyst. Typically the regenerator 10 may hold on the order of 300 tons of fluidized catalyst and the bed 12 may be about 10 feet deep. The superficial gas velocity may be about 3 ft/s for a bed in the turbulent fluidization regime. Air entering at the air grid 16 forms large bubbles or even streamlines in the catalyst bed 12. These bubbles or streamlines entrain catalyst as the bubbles rise to the surface 15 of bed 12. It has been found that while the catalyst phase can be well mixed in the vertical direction due to the bubbles and streamlines, the catalyst may not be well mixed in the radial or angular directions, so that compositional gradients may exist at any bed depth in the plane of the top 15 of bed 12.

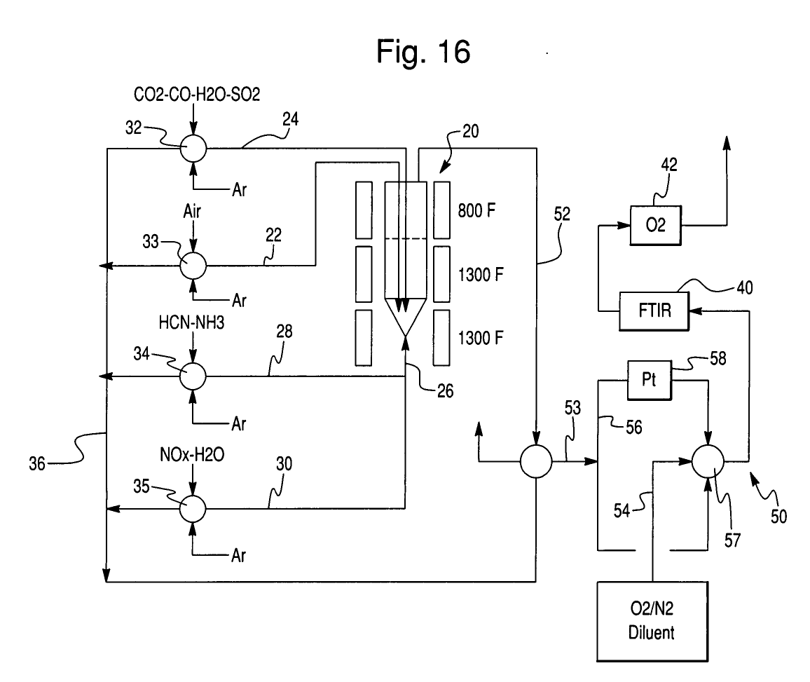

It is the inventors' belief that the catalyst experiences gas phase compositional cycling while traveling up and down in one area of the regenerator. This cycling is shown by arrow 18. Beginning at the air grid 16, catalyst is entrained in an air bubble and transported in about 1 second to the top 15 of the bed 12 where the atmosphere is rich in combustion products. From there the catalyst drifts down through the dense emulsion phase of bed 12 as the gas phase becomes richer in oxygen. Depending on the superficial velocity of the regenerator, the actual return time to the air grid may be as little as 3 s. We have operated with a 3 minute cycle time, however, representing a much lower fluidization velocity, in part due to instrumental limitations. When the catalyst eventually returns to the air grid 16 it repeats the cycle. Cycles repeat indefinitely and are not related to the regenerator residence time (inventory/external circulation rate). This internal redox cycling has been ignored in previous test method designs. The apparatus used for testing is shown in FIG. 16.

Referring to FIG. 16, for the fluidized bed reactor 20 a glass tube-in-a-tube gas injector design was used. At the top of the reactor 20, air flow via line 22 was directed into the center tube and CO₂/CO/SO₂/H₂O flow via line 24 was directed into the annular space between the tubes (not shown). The gas injectors were inserted into the fluidized bed, preferably to the bottom of the fluidized bed, to prevent reaction between the gas mixtures before entering the bed 20. As shown the bottom of the reactor 20 is conical with a small bore opening instead of a glass frit. Via a tube (not shown) in the bottom of reactor 20, a flow of fluidizing gas (N₂ or Ar) via line 26 and containing HCN, NH₃, NOx and H₂O via lines 28 and 30 was provided. Four port switching valves 32, 33, 34 and 35 allowed the reactants to pass through a heated bypass line 36 and directed argon into reactor 20. The air, CO₂CO/H₂O/SO₂ mixture, and the HCN/NH₃/NOx/H₂O injection points were positioned closely together, preferably within about 1 cm of each other, so that the gases were allowed to mix under cover of the fluidized bed. Gas analysis was accomplished by FTIR gas analyzers 40 and mass spectrometers. The process gas requires dilution before analysis but these analyzers commonly have adequate detection limits. Mass spectrometric analysis of combustion gases is difficult however, particularly for determination of N₂ and NH₃. FTIR gas analyzers with a gas cell capable of operating at 450° F. or higher, coupled with an oxygen analyzer 42 were used. These types of analyzers however are unable to measure N₂, H₂ and H₂S, and calibrations may not be available for S₃.

A post-reactor catalytic converter 50, was employed to help with the gas analysis. H₂ may be formed at percent levels by the water-gas shift reaction for example, but H₂ cannot be analyzed by FTIR. To overcome this, the reactor flow was blended via lines 52 and 53 with a diluent of N₂ or 0.5% O₂ in N₂ and the blend via line 56 passed through a Pt oxidation catalyst 58 at 1300° F. The diluent passes first through four port valve 57 via line 54 and can be directed to blend with reactor flow 53 and to catalyst 58 via line 56 or the diluent can be directed via valve 57 to flush catalyst 58 and cause reactor flow from line 53 to bypass catalyst 58. The oxygen in the diluent was sufficient to convert any H₂ to H₂O and H₂S to SO₂/SO₃ with the majority being SO₂. The tubing and fittings used to build the reactor 50 were glass or pretreated with a protective coating such as Sulfinert® SiO₂ treatment to prevent adsorption and sulfiding at high temperatures however. NH₃ and HCN are also mainly converted to NOx, so use of this type of reactor with plumbing to place the reactor on and off line enables reasonably complete determinations to be made even with a standard CO₂—CO—SOx-NOx continuous emission monitor.

In general, blends containing 20% of the experimental additives and 80% of a standard zeolitic FCC catalyst were made and steamed at 1500° F. for 2 hours. The steamed blend was subsequently further blended as 50% steamed additive blend, 40% of steamed FCC catalyst without any additive, and 10% of undiluted fresh additive. Each recombined blend therefore contained 10% steamed additive and 10% un-steamed additive, without any unsteamed zeolitic FCC catalyst. 2 grams of the resulting 50-40-10 blends were then further diluted with 18 grams of steamed FCC catalyst, and placed in the fluidized bed test apparatus described above with the reaction zone at 1300° F. Test gases which contained representative amounts of CO₂, CO, H₂O, O₂, SO₂, NO, HCN, NH₃ and inert diluent were admitted to the catalyst mixtures in the reactor at a space velocity with respect to the additive which is representative of an FCC regenerator operating with an E-cat containing 2% additive (ca. 107,000 hr⁻¹). After about 30-60 minutes on stream, the effluent analysis was captured for reporting.

Precious metal promoters were generally tested without steaming the additive, instead blending the fresh additive into of the same steamed FCC catalyst base used above to form a 20 g charge.

The fluid bed performance testing reactor 20 was a 1″ diameter quartz tube with a conical bottom and no frit. A gas manifold supplied separate streams of NO/H₂O, NH₃, and HCN in diluent Ar that were blended and then sent through the bottom fluidizing tube at a constant 165 STP cc/min. The sum of the CO₂/CO/SO₂/Ar and the air flow rates were constant at 95 STP cc/min but these individual flows varied systematically. There were also several sweeper gases of a few cc/min used to keep pressure gauges and other instrumentation clear of condensate and corrosives. 20 g of test catalyst was placed in the reactor and surrounded the feed gas injection point. The three feed gases mixed under cover of the test catalyst, bubbled up through the bed and exited the reactor through a quartz filter. A three zone heater was wrapped around the reactor with the zone(s) above the top of the fluid bed operating at 800° F. and zone(s) below operating at 1300° F. A bed thermocouple may be used and remained inside the air injector tubing and extended to the end of the injector but not beyond it. Downstream tubing was stainless steel. High temperature GC switching valves and the tubing were heat traced at 450° F. or higher. 2 LPM of N₂ or 0.5% O₂ in N₂ was added as diluent to improve the response time and linearity of an FTIR, also heated to 230°-240° C. Further downstream was a gas drier and oxygen analyzer.

The air and CO₂/CO (fuel) gases were not fed to the reactor at a steady rate. Instead, air/fuel equivalent ratio cycling was done following the method of the previously mentioned U.S. Provisional Applications. Parameters generally used were 97% oxygen conversion, 3 minute cycle time, 2% CO/₂% CO_{2/}4% H₂O at lambda=1 (stoichiometric mixture), along with about 279 ppm SO_{2,} 389 ppm NO, 391 ppm NH₃, and 448 ppm HCN. This set of parameters led to about 7.5% O₂ at the end of the cycle and about 2.3% CO and CO₂ at the beginning of the cycle. CO concentrations were held low as a safety consideration.

### Example 1

### Test Methodology

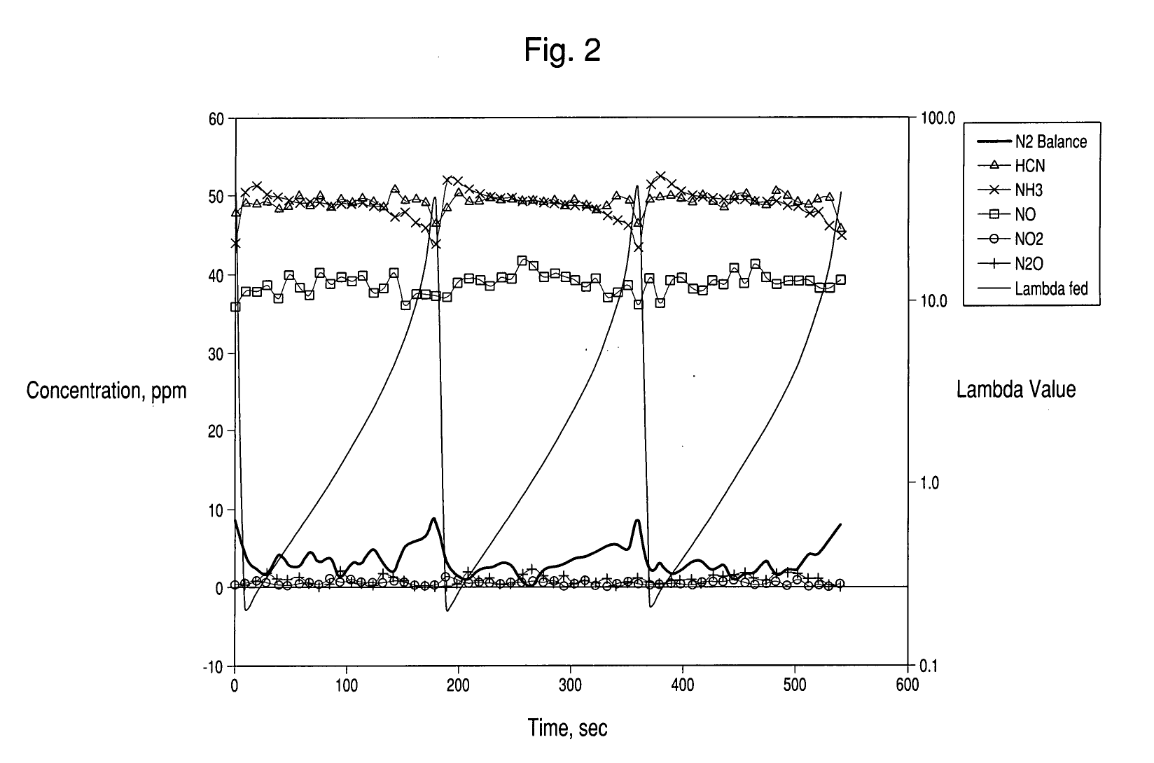

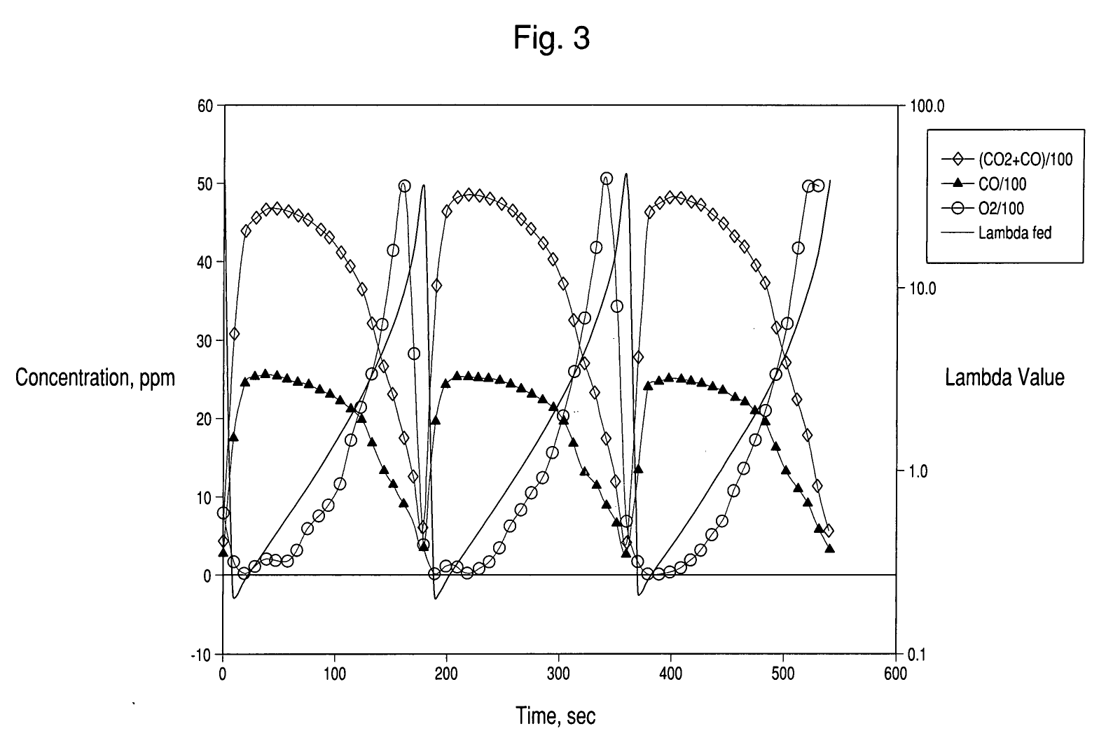

In this example, concentrations for three air/fuel (lambda) cycles were measured when the reactor feed was bypassed directly to the analyzer without reaction, see FIGS. 2 and 3. CO/100 exhibited the exponential shape of the fuel gases which are analogous to the combustion products in the fluid bed. The O₂ had the opposite shape of the CO. Vertical dashed lines indicate the time where the feed transitions between fuel-rich and fuel-lean (lambda<1 or >1, respectively). Measured HCN, NH₃ and NO were roughly constant with time. These measured concentrations were at (260/2260) dilution so the reactor levels were much higher. A nitrogen species material balance was calculated and the result was about 0-5 ppm N₂, indicating the precision of the method. SO₂ followed the CO concentration and the sulfur material balance was good to about 5 ppm, but both the N₂ and S balances were biased high to zero. Some of the results below are reported as integrated yields over three lambda cycles. Where lean and rich data can be segregated, these are reported separately.

### Example 2

### Comparative Catalyst Preparations with Precious Metals

A CO promoter was prepared by impregnating calcined kaolin microspheres with 500 ppm platinum as the metal. This and the other precious metal promoters were tested without steaming by blending the promoters with FCC catalyst that was independently steamed at 1500° F. for 4 hours. The promoter was blended down so that the Pt concentration in the mixture was in the neighborhood of 0.5 ppm Pt.

The USP-500 CO promoter marketed by BASF Catalysts LLC (formerly Engelhard Corp.) contains 500 ppm Pt on a Puralox alumina support.

A Pt promoter was made by impregnating Puralox support with 8 ppm Pt.

A palladium promoter was made by impregnating Puralox support with 500 ppm Pd.

Rare earth modified precious metal (PM) CO promoters were made by first impregnating Puralox with cerium-containing rare earth solution, as is well known in the art, then drying, calcining, and then impregnating with 500 ppm of either Pt, Pd, or Rh.

All of these PM promoters were used fresh and blended down to about 0.4 ppm PM, as in the Pt/kaolin case.

### Example 3

### Comparative Catalysts Made with Base Metal Oxides

Two series of base metal catalysts were made by impregnating blended solutions onto the same Puralox microspheroidal support used above, followed by drying and then calcination at 1400° F. Metal nitrate hydrate salts were dissolved together in water to form an integral number of volumes of the pore volume available in the support, since solubility limits sometimes dictated multiple impregnations. Both series contained 10 wt % added mixed metal oxides. The first series were variants on A₁Fe₂O₄ and the second series were modifications of a base recipe of A₁Mn₂Oₓ. The metal atom ratios and the metal oxide stoichiometry used for the purpose of the loading calculations are shown in Table 1. These are only comparative samples which turned out to be equivalent or perhaps marginally better in NOx yield at constant CO promotion level. These base metal promoters were tested as 50-40-10 blends as described above, but a few were run at higher space velocity to provide data at lower CO₂/CO ratio.

The lambda sweep test was run and it was found that the NOx from the lean side, which corresponds to the gas environment in the lower parts of the regenerator dense bed was highest and increased with increasing promoter activity. The NOx yield integrated over time for the lean part of the cycling was roughly linear with Log(CO₂/CO), so that the slope was fairly constant with space velocity and characteristic of the promoter. Table 1 lists the available results together with benchmarks for no additive and typical doses of platinum. Fully promoted equilibrium catalyst gave CO₂/CO of 10-20. The base metal promoters, having 2000 ppm of base metal oxide in the blends, were at least four orders of magnitude less active per unit metal than platinum additive, but the slope of the NOx curve (NOx selectivity) remained similar to platinum.

TABLE 1
Comparative water-gas shift catalyst compositions at 10 wt % MOx loading
and tested at 107,000 hr⁻¹ with respect to the additive.

| | | | | | | | | | Integrated | Integrated |
|---|---|---|---|---|---|---|---|---|---|---|
| Comparative | Fe | Ni | Cu | Zn | Co | Mg | Ca | Mn | CO₂/CO | NOx/Log(CO₂/CO) |
| 1 | 8 | 3 | | | | | | | 18.1 | 12.3 |
| 2 | 8 | 4 | | | | | | | 21 | 13 |
| 3 | 8 | 5 | | | | | | | 16 | 14 |
| 4 | 8 | | 4 | | | | | | 162 | 9.4 |
| 5 | 8 | | | 4 | | | | | | |
| 6 | 8 | | | | 4 | | | | | |
| 7 | 8 | 2 | 2 | | | | | | 20 | 12.6 |
| 8 | 8 | 2 | | | 2 | | | | | |
| 9 | 8 | 2 | | | | 2 | | | | |
| 10 | 8 | 2 | | | | | 2 | | 13 | 19 |
| 11 | 8 | 1 | | | | | 3 | | | |
| 12 | 8 | | | | | | 4 | | 9 | 17 |
| 13 | | | | | 1 | | | 1 | | |
| 14 | | | | | 2 | | | 1 | 4 | 19 |
| 15 | | | | | 3 | | | 1 | | |
| 16 | | | | | 1 | | | 2 | | |
| 17 | 1 | | | | | | | 2 | 10 | 12.6 |
| 18 | | 1 | | | | | | 2 | 5.4 | 13 |
| 19 | | | 1 | | | | | 2 | 50 | 11 |
| 20 | | | | | 3 | | 1 | 8 | | |
| 21 | 3 | | | | | | 1 | 8 | 20 | 9 |
| Blank | — | — | — | — | — | — | — | — | 1-2 | — |
| Pt promoter | — | — | — | — | — | — | — | — | 10-1000 | 12-18 |
| MOx | Fe₂O₃ | NiO | CuO | ZnO | CoO | MgO | CaO | MnO₃ | Mol/mol | Umol |

### Example 4

### Catalysts of the Invention

The foregoing base metal oxide catalysts are much less active than the PM catalysts in common use. The alumina support particles are only ca. 80 um in diameter and fluid beds are considered very good for providing heat transfer. Hence the art had not considered the possibility of heat and mass transfer limitations and any impact of such limitations. The Cu₁Fe₂ and Cu₁Mn₂ recipes had given the highest CO₂/CO ratios at 10% loading but still had relatively high NOx. Variations on these recipes were prepared using the previous data for guidance, but now reducing the total metal oxide loadings to 0.5-2.0 wt %. Four of the metal atom ratio recipes were also prepared at 10 wt % loading to directly test any effects for varying loading. Metal nitrate hydrate salts were dissolved together and impregnated onto the alumina support. These materials were dried, calcined, blended, steamed and readied for testing as 50-40-10 blends, just as was done above. In the cases where the total metal oxide loading was less than 10 wt % on the additive however, less dilution was done before activity testing so that 2% and 1% samples could be tested at the same 2000 ppm of active base metal oxides in the reactor charge as was used before. (Only 1000 ppm of base metals were present on the 20 g charge of the 0.5 wt % loading additive however.)

Conventional thinking would lead one to expect no variation of CO₂/CO with metal oxide loading on the promoter. Unexpectedly however, the CO₂/CO results did change with loading, with maximum CO conversions being found at intermediate loading, see Table 2. Most surprisingly, the NOx yield for constant metal atom ratio and CO₂/CO was much reduced at the lower loading levels. The improved reduced NOx selectivity was also convincingly better than the precious metal promoters, with or without rare earth modifiers.

TABLE 2

| Run | | | | | | | Wt % | | NOx/ |
|---|---|---|---|---|---|---|---|---|---|
| No. | Fe | Ni | Cu | Ca | Mn | La | MOx | CO₂/CO | Log(CO₂/CO) |
| 22 | 8 | 1 | 3 | | | | 1% | 207 | 6.5 |
| 23 | 8 | 1 | 2 | 1 | | | 1% | 35 | 7.1 |
| 24 | 8 | 1 | 2 | | 1 | | 1% | 40 | 7.6 |
| 25 | 8 | 1 | 2 | | | 1 | 1% | 27 | 7.3 |
| 26 | 6 | | 2 | | 2 | | 1% | 32 | 7.8 |
| 27 | 6 | 1 | 3 | | 2 | 2 | 1% | 42 | 8.3 |
| 28 | 6 | | 2 | | 2 | 2 | 1% | 65 | 3.9 |
| 29 | 6 | | 3 | | 1 | 2 | 1% | 48 | 5.9 |
| 30 | 8 | | 4 | | | | 10% | 41 | 10.9 |
| 31 | 8 | | 4 | | | | 2% | 282 | 6.6 |
| 32 | 8 | | 4 | | | | 0.5% | 163 | 4.8 |
| 33 | | | 4 | | 8 | | 10% | 79 | 10.2 |
| 34 | | | 4 | | 8 | | 2% | 101 | 5 |
| 35 | | | 4 | | 8 | | 0.5% | 35 | 4.9 |
| 36 | 3 | | | 1 | 8 | | 10% | 12.6 | 15.5 |
| 37 | 3 | | | 1 | 8 | | 1% | 9.1 | 5.8 |
| 38 | | 1 | 3 | | 8 | | 1% | 170 | 6.0 |
| 39 | 2 | | 1 | 1 | 8 | | 1% | 40 | 5.6 |
| 40 | 2 | 1 | | 1 | 8 | | 1% | 10.9 | 4.4 |
| 41 | 1 | 1 | 1 | 1 | 8 | | 10% | 40, 1715 | 10.4, 7 |
| 42 | 1 | 1 | 1 | 1 | 8 | | 1% | 10 | 3.1 |
| 43 | 1 | 1 | 2 | | 8 | | 1% | 46.5 | 5.2 |

CO oxidation is reportedly not structure sensitive, however active site structure is extremely important in selective oxidation reactions. One may propose that such structure sensitivity is responsible for the improvement in reduced NOx selectivity. Without wishing to be bound by any theory, we believe the additives with the higher base metal oxide loadings are both heat and mass transfer limited. For very high activity or loading, the effectiveness factor is less than one due to extreme mass transfer limitation. At intermediate activity and loading, the exponential impact of overheating overwhelms the mass transfer limitation and the effectiveness factor is greater than one. Additive microsphere temperatures may significantly exceed the average bed temperature and degrade selectivity to increased NOx however. At the lowest loading levels, additive microsphere temperatures may be similar to the bed temperature and the selectivity to-reduced NOx may possibly be more favorable.

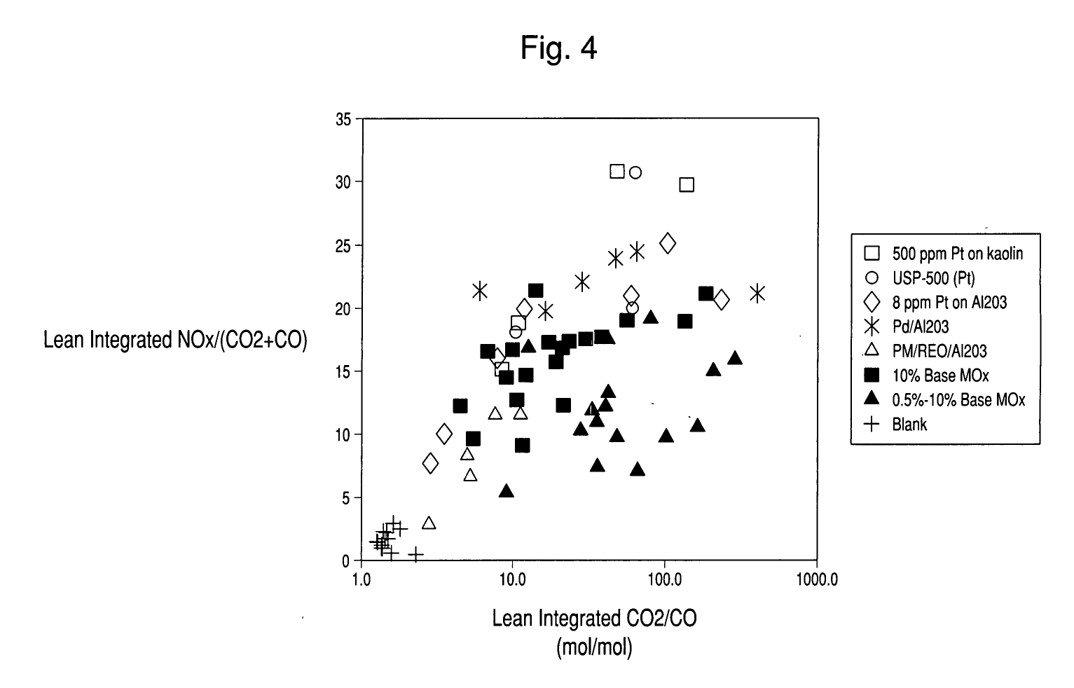

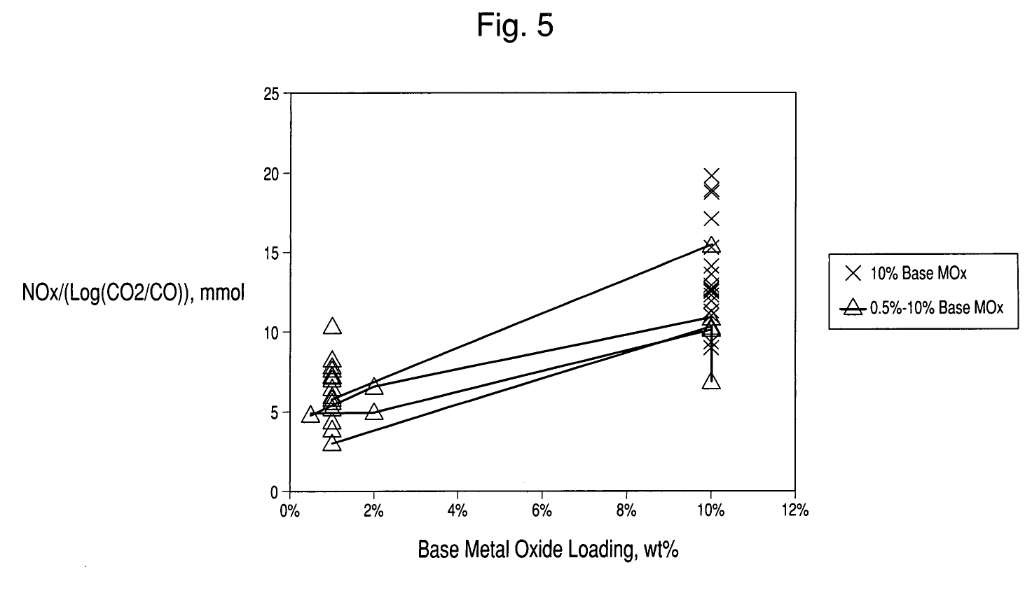

The integrated yield of lean side NOx per unit integrated (CO₂+CO) versus integrated lean side CO₂/CO ratio results for the comparative PM catalysts, the comparative base metal oxidation/water-gas shift catalysts at 10 wt % loading, and the low activity and loading base metal low NOx CO promoters of the invention, as provided in the preceding Tables 1 and 2, are plotted together in the following Figures. The PM additives performed similarly: conventional 500 ppm Pt additives, a low 8 ppm loading of Pt, using Pd all gave similar results after adjusting for CO₂/CO. Using PM on rare earth-modified alumina may have provided marginally better (reduced) lean side fresh NOx selectivity. Some of the 10% loading base metal oxide recipes may have been marginally improved as well, but verification would be in order. Many of the samples labeled 0.5%-10 wt % Base MOx were dramatically improved however. This group of plotted data in FIG. 4 include four samples at 10 wt % MOx however, clouding the interpretation of the Figure. The following plot in FIG. 5 of the NOx/Log(CO₂/CO) measure of NOx selectivity as a function of base metal oxide loading on the additive confirms the importance of the loading effect and the utility of the invention. This can plausibly be attributed to either microsphere overheating or a structure sensitivity in NH₃—HCN oxidation to NOx or the Selective Catalytic Reduction (SCR) of NOx on the additives of the invention.

### Example 5

The performance of the invention and prior art additives is now compared in detail to illustrate the utility of the invention.

The samples were: a steamed FCC catalyst with no additives, the same base catalyst blended with fresh 500 ppm Pt/Al₂O₃ additive sufficient to reach a CO₂/CO ratio (by integration of the lean side data) of 22, steamed 500 ppm Pd on CePr/Al₂O₃ additive sufficient for CO₂/CO=21, a 50-40-10 fresh/steamed mixture of the novel CO promoter Cu₁Mn₂O₇ on Puralox alumina at 0.5 wt % loading dosed for CO₂/CO=22, a fresh/steamed mixture of a novel partial burn additive FeSbCuOx (CO₂/CO=2), and a steamed CuCePr/Al₂O₃ NOx additive blended with sufficient fresh Pt promoter to reach an 18 CO₂/CO ratio.

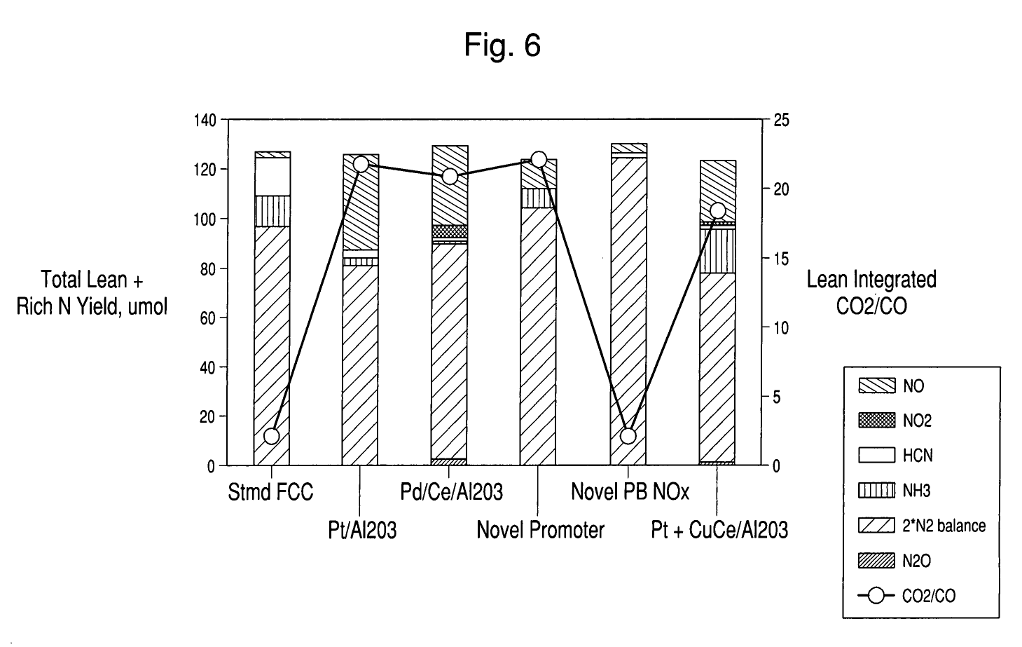

A summary of the nitrogen compound yields integrated over the entire lambda cycle can be found in the bar chart FIG. 6. The separate line shows that the CO₂/CO ratios were close between the two unpromoted samples or among the four promoted samples, so that the promoter NOx rankings can be accepted as they appear. The novel promoter of the invention yields much lower NOx than the Pt, Pd/REO, or Pt+CuCe additive systems that represent the state of the art The nitrogen yield, reported as 2*N₂ yield, is also higher for the promoter of the invention, although the ammonia byproduct is somewhat higher than the Pt and Pd cases. NH₃ is a non-regulated gas which is likely to combust to N₂ anyway, however.

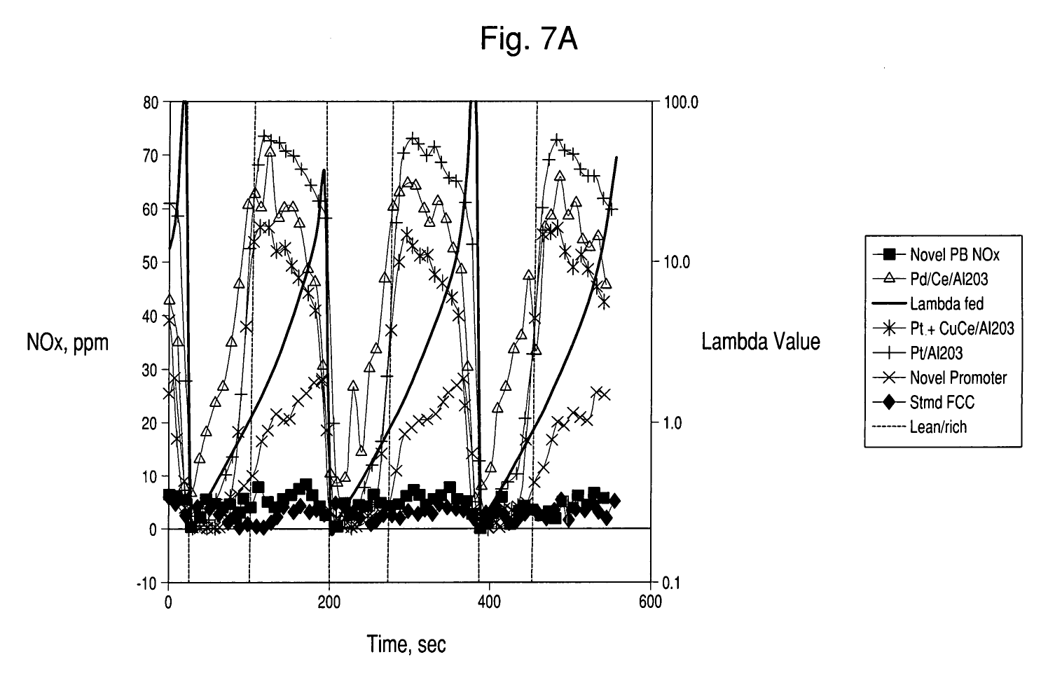

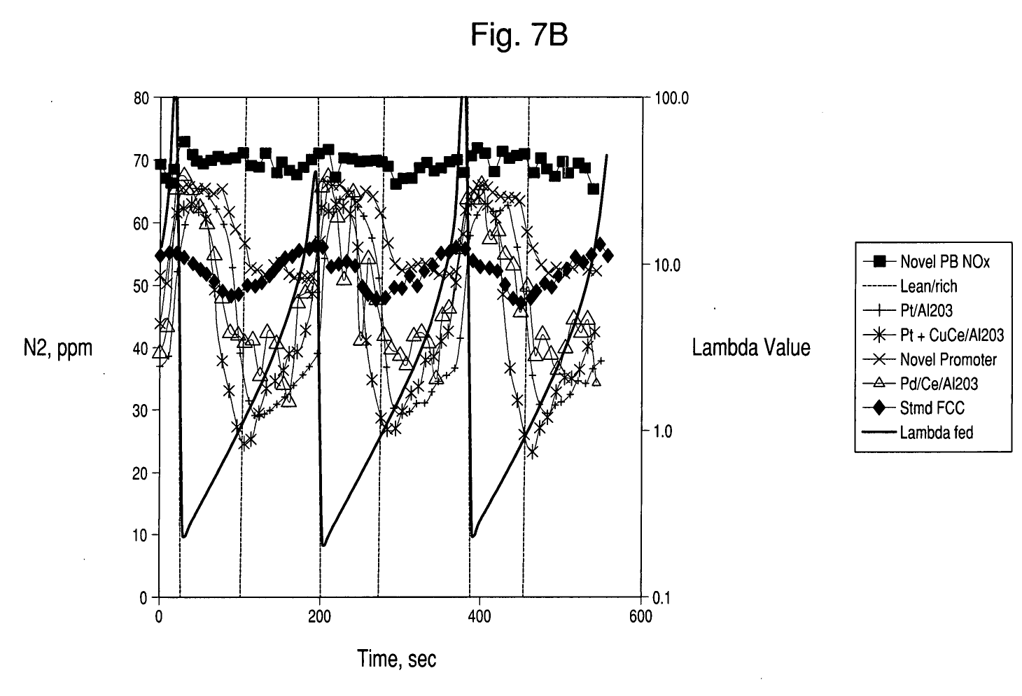

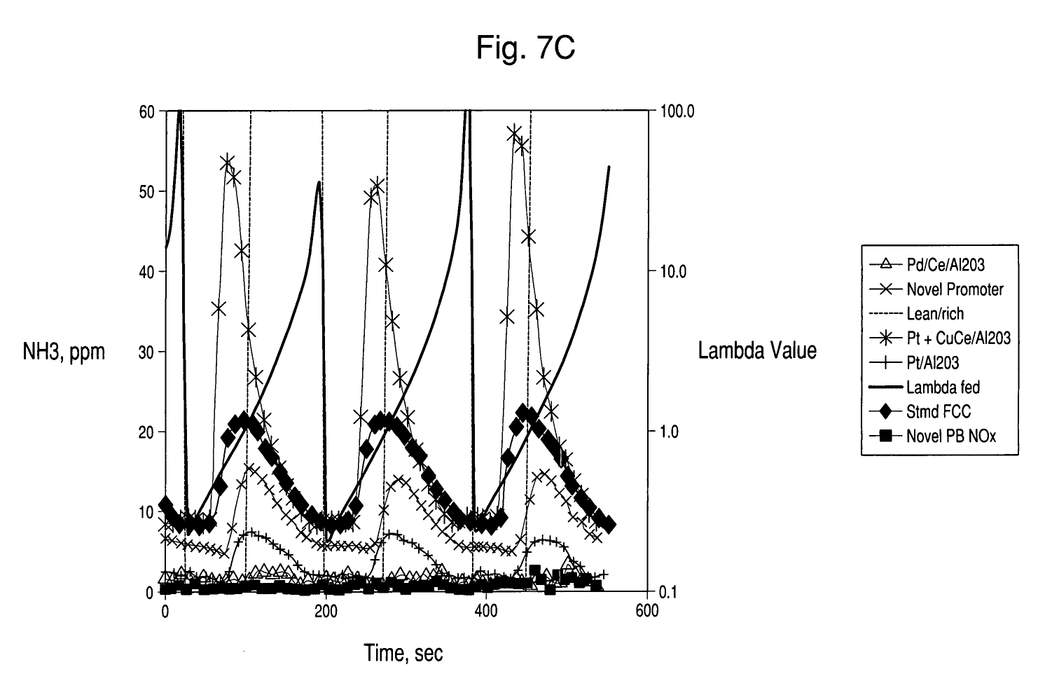

The next plots show the transient concentrations of NOx and N₂. The concentration profiles were steady over three cycles, indicating that the process had equilibrated. The lean and rich parts of the cycle are separated by a vertical dashed line and the lambda value as a function of time is also shown. FIG. 7A shows that the Pt and Pd promoters made NOx on the lean side, but the rare earth additions appeared to have improved the results somewhat at equivalent lambda and CO₂/CO. The novel promoter made much lower NOx at equivalent CO₂/CO and lambda values, however, although lean side NOx was still found. Rich side NOx was much lower in all cases. In these cases the rich side N₂ yield for the promoters was higher, FIG. 7B but often times NO on the rich side was reduced instead to NH₃. The novel partial bum additive and control catalyst appeared to remove nearly all the NOx fed, but there may been some residual effect of combustion and NO+NH₃ reaction to N₂ above the bed. The nitrogen balance shows the lean production of NOx led to a deficit in lean N₂, but that all the promoters made significant N₂ on the rich side. This rich feed mixture is analogous to the top of the partial burn bed or a region in the full burn dense bed that receives insufficient air supply.

The other nitrogen species are shown in FIG. 7C. The Pt+CuCe/Al₂O₃ additive blend left large amounts of ammonia unconverted around lambda=1 but the Pd/Ce/Al₂O₃ promoter surprisingly converted all of the ammonia, as did the partial burn additive. The novel promoter also left significant amounts of NH₃ unconverted around lambda=1. HCN was completely removed by all additives, except for a rich side residual by Pt/Al₂O₃.

The rate of production of combustion products including nitrogen species is highest in general at the bottom of the dense bed near the air grid, because this is where the concentration of oxygen is highest. The results in general show that the HCN and NH₃ were converted to NOx with the highest efficiency at these high lambda values. There is more propensity to make nitrogen in the rich region, but rich regions will not exist in the ideal regenerator at full burn and excess oxygen. It is therefore essential for low NOx promoters to have high selectivity to N₂ and low yields of NOx on the lean side. The invention exhibits this valuable trait.

### Example 6

### Further Comparisons of Detailed Performance for the Promoters of the Invention

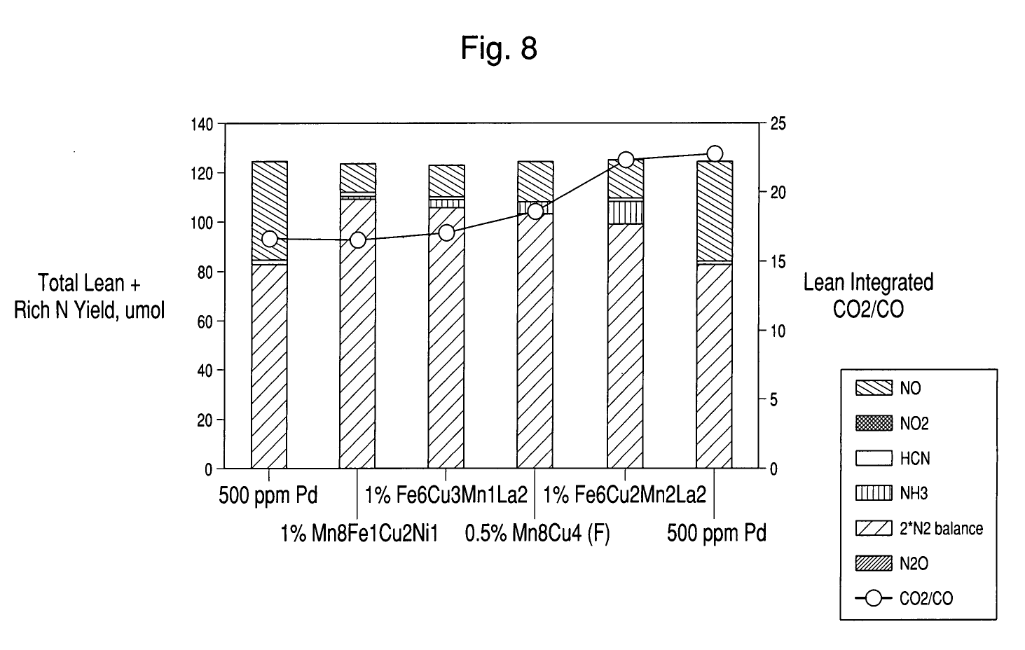

The lambda sweep runs from Example 4 were sorted by CO₂/CO and tests on four different catalysts of the invention were graphically compared to runs on fresh 500 ppm Pd/Al2O₃ which bracketed the invented catalyst's CO₂/CO ratios. The Mn₈Cu₄ catalyst was tested fresh but the other base metals catalysts were tested as 50-40-10 blends at GHSV of 107,000 hr⁻¹ with respect to the additive. The bar chart, FIG. 8 shows the integrated overall nitrogen compound yields together with the CO₂/CO ratio. It is clear from the chart that the catalysts of the invention had much lower NOx than the prior art precious metals at constant integrated CO₂/CO.

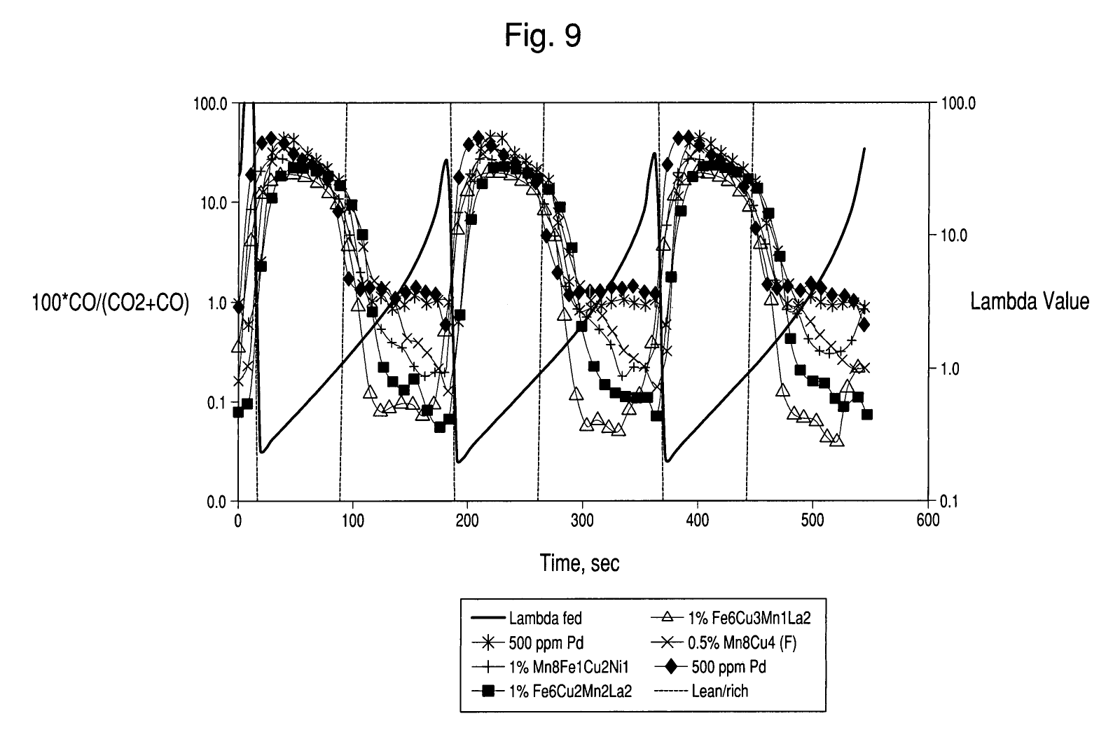

While the CO₂/CO integrals were similar, the detailed CO₂/CO curves shown in FIG. 9 differed in shape, indicating that the base metal oxide catalysts in fact had higher CO promotion activity deep in the lean environment. The NOx advantage for the invention may therefore be larger than it appears.

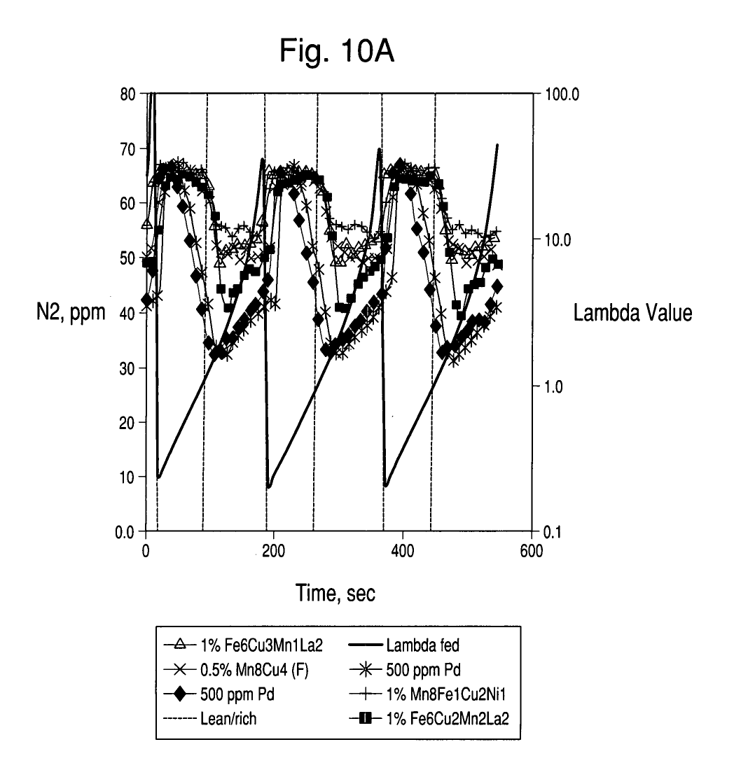

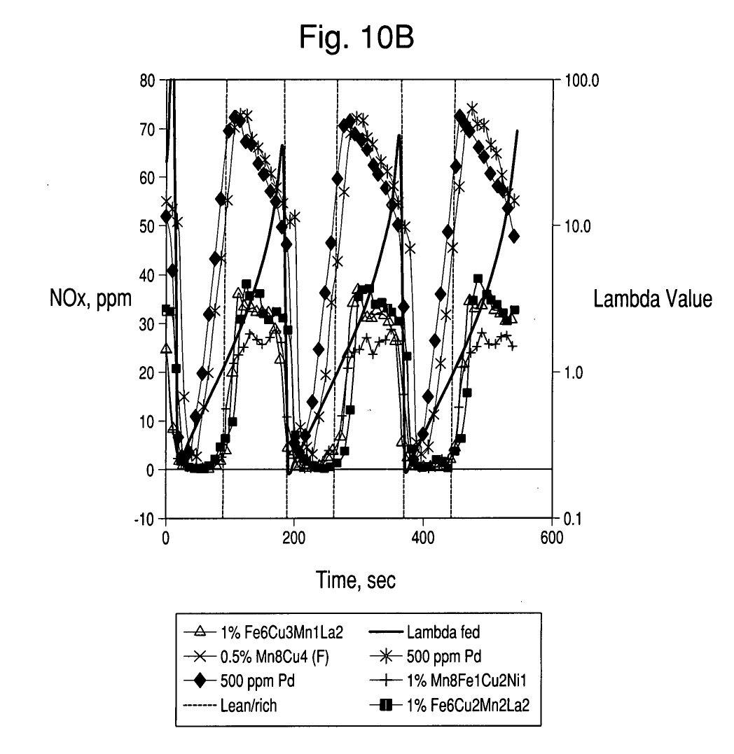

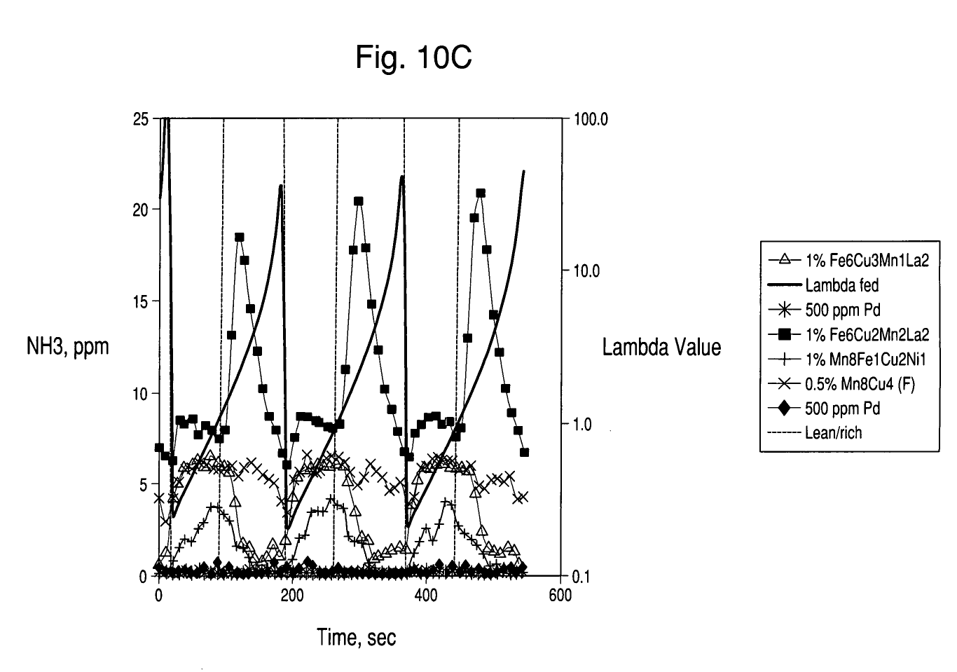

The subsequent pair of plots, FIGS. 10A and 10B, show the detailed transient response of N₂ and NOx. While the general shapes of the curves are similar, it is clear that the catalysts of the invention made more N₂ in the lean environment, and much less NOx than the prior art Pd. This suggests higher rates of production of N₂ in the lower parts of the dense bed and near the air grid, where the production rate of NOx precursors is the highest. The bar chart, FIG. 8, has already shown that the other major species was NH₃. The detailed NH₃ transients data in FIG. 10C show that the rate of reaction of NH₃ depends on lambda value as well as catalyst. These transients are rich in kinetic information and implications. All of the additives removed HCN.

### Example 7

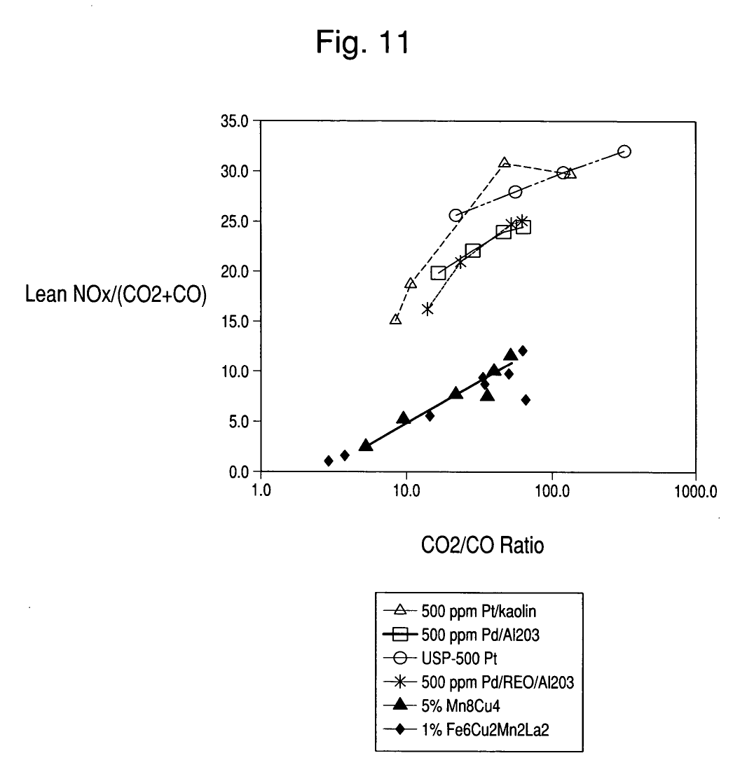

The novel promoters of Example 4 seemed to have excellent (reduced) lean side NOx selectivity. A GHSV study on two of these promising additives was conducted to confirm the low NOx performance. Comparative Pt and Pd-based promoter tests at varying GHSV that were run side by side with the novel promoters are also shown. The PM promoters were all fresh. The novel promoter samples were most often tested as a 50-40-10 blend of fresh and steamed additive, but a few runs made on either all fresh or all steamed additive seemed to have the same selectivity, and so are also included in the plot. The data in FIG. 11 confirm dramatically lower NOx at constant CO oxidation activity using the promoter of this invention.

### Example 8

### Effect of Oxygen Conversion: Partial Burn, Full Burn, and Excess Air

An oxygen conversion parameter in the lambda sweep model determines the split between lean and rich conditions, and this parallels the operation of a regenerator at varying degrees of combustion.

The oxygen conversion parameter was varied while using a single charge of 1% Fe₆Cu₂Mn₂La₂Oₓ catalyst of the invention. The impact of the parameter on the excess % CO or excess % O₂ in the test reactor at the time of highest CO feed rate is given in Table 3. This gas composition is meant to mimic the gas exiting the top of the regenerator dense bed.

TABLE 3

| | O₂ Conversion | | | | |
|---|---|---|---|---|---|
| | 99% | 97% | 86.7% | 75.7% | 65% |
| Excess CO | 2.28% | 1.91% | 0% | — | — |
| Excess O₂ | — | — | 0% | 1% | 2% |
| Operation | Partial | Partial | Stoichiometric | Full burn | Full burn |
| | Burn | Burn | | | |

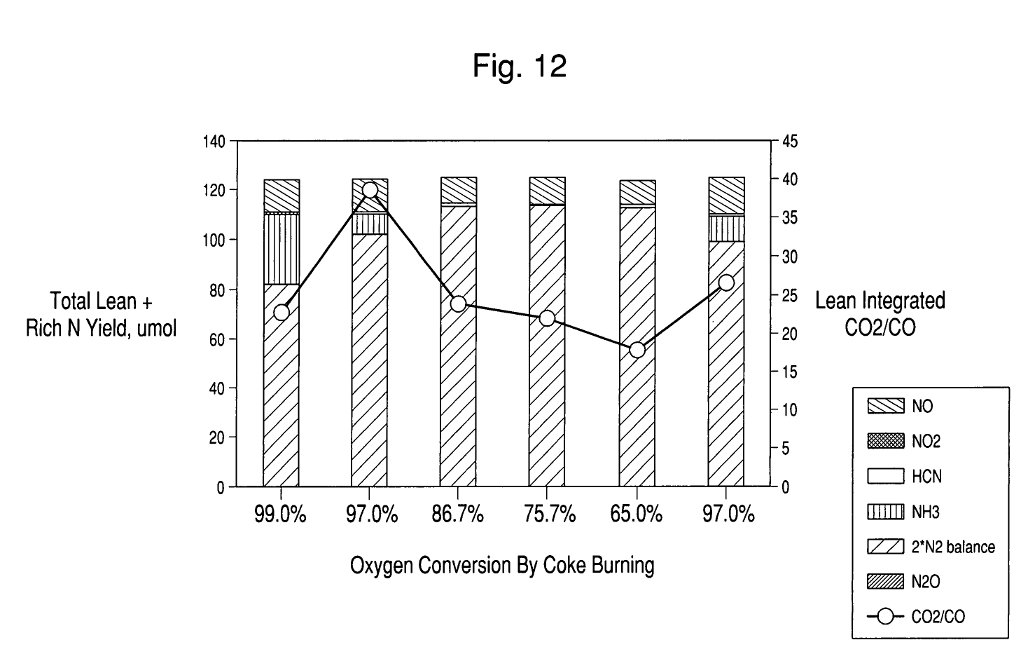

The bar chart, FIG. 12 summarizes the impact on the nitrogen species. It was found that running at high oxygen conversion in the dense bed reactor model led to the elution of NH₃. This is meant to simulate the net reducing conditions present at the top of the dense bed in partial burn. At oxygen consumption below the stoichiometric point of 86.7% conversion there is an excess of oxygen present at all lambda sweep times or depths in the regenerator dense bed, and this is full burn. Under these conditions ammonia and HCN selectivities were less than one percent and the total and the yield of N₂ actually increased vs. partial burn operation. Quite surprisingly, the NOx yield for the catalyst of the invention was actually smaller under the full burn model conditions. The activity of this additive for CO conversion was also diminished however.

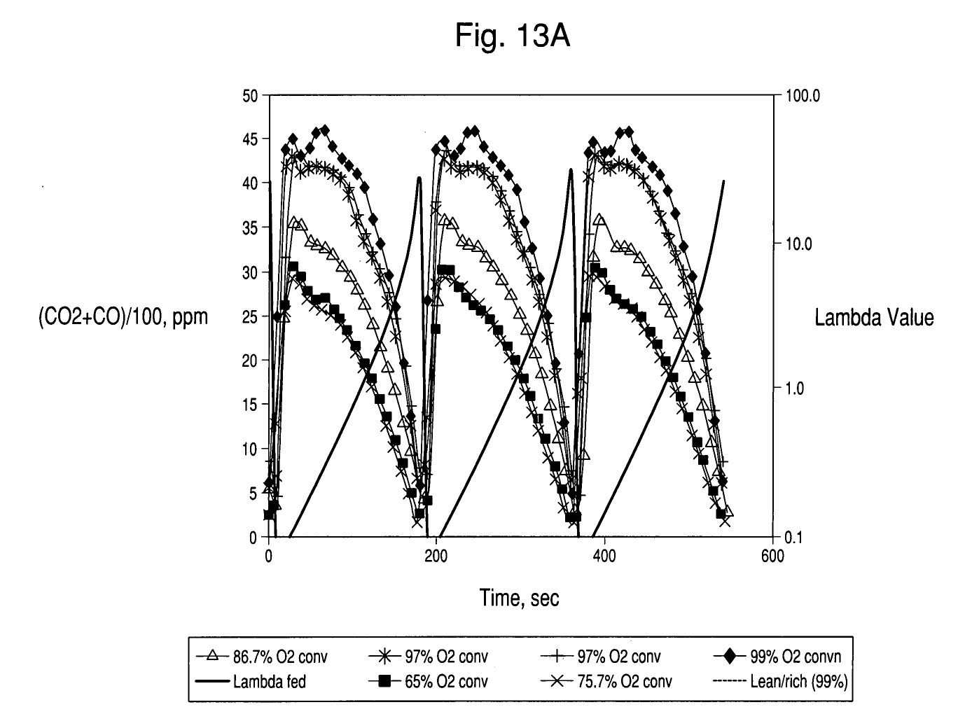

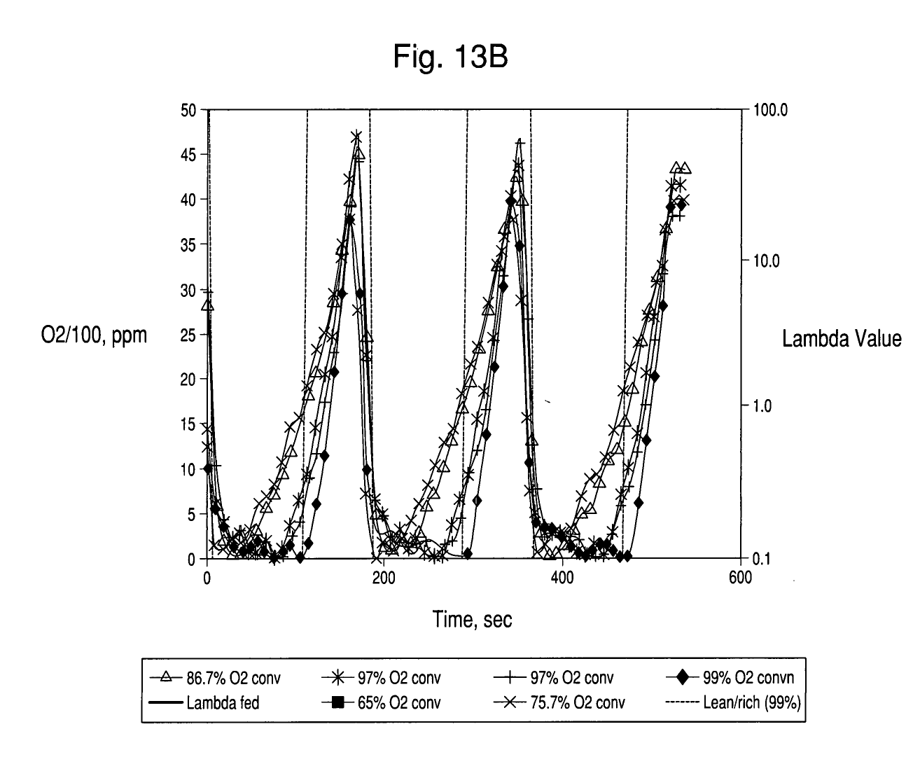

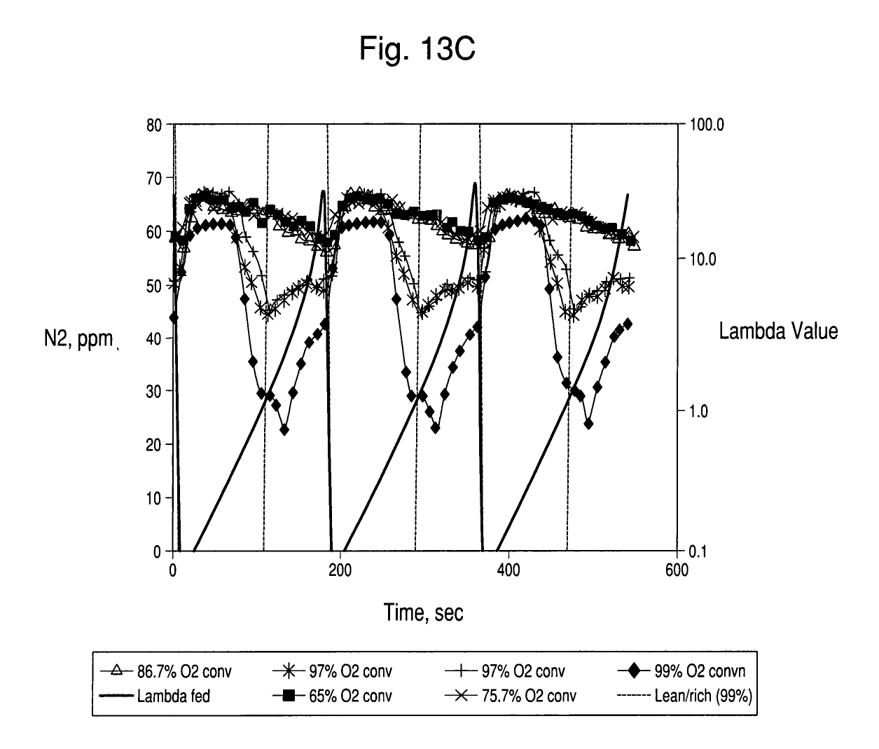

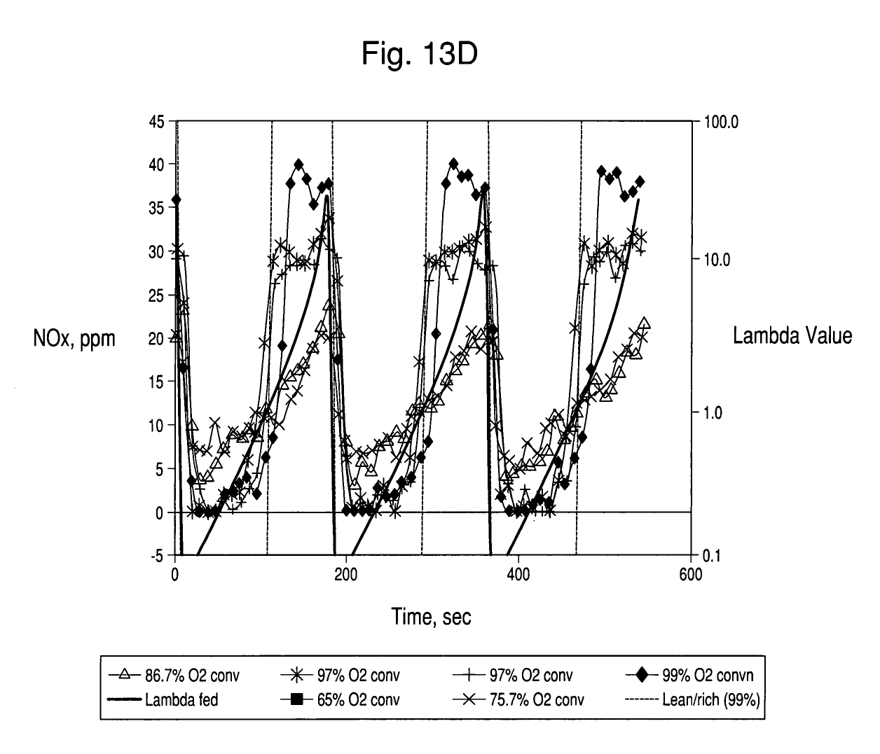

Changing the oxygen conversion parameter led to shifting in the relative amounts of CO₂/CO and air, as seen in the next concentration profile. FIGS. 13A-D confirm that surprising result that the invented catalyst actually made more N₂ and less NOx when the reactor was run with more air and less fuel, under excess O₂ conditions

### Example 9

### Performance Verification by Coke Burning

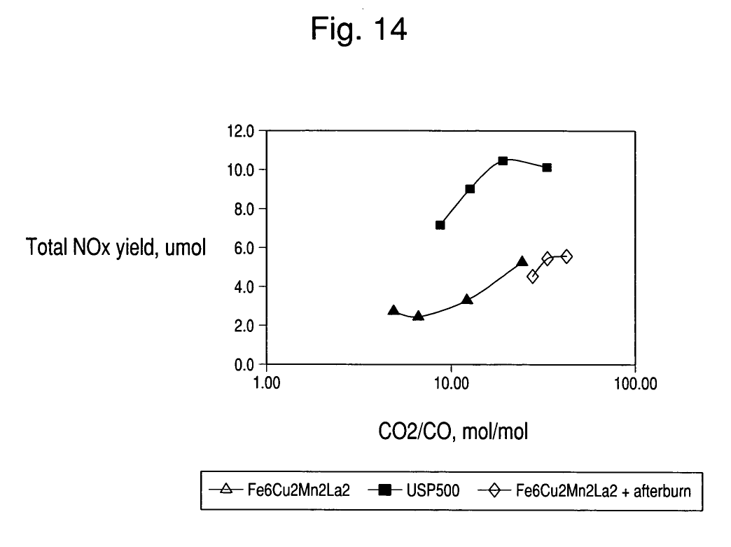

As a final verification of the novel low NOx promoter, coke burning was done in the presence of the Fe₆Cu₂Mn₂La₂ promoter and compared to USP-500 platinum CO promoter. The fluid bed was initially charged with 2 g of 50-40-10 base metal additive and 16 g of steamed FCC catalyst diluent. To the 1300° F. fluidizing bed was then charged 2 g of steamed catalyst that had been coked by gas oil cracking to about 0.8 wt % coke. Combustion product gases were generated in situ and the promoters converted them to CO₂, NOx, etc. Three more 2 g charges were added, this time the coke containing further increments of fresh promoter. The NOx yield obtained is plotted against the CO₂/CO obtained in the coke burn, FIG. 14. The data confirms that the low activity base metal promoters of the invention made about half the NOx of the prior art Pt promoter under real coke burning conditions and at constant promotion level.

Afterburn affects the refinery operation and our apparatus has been designed and operated to eliminate any influence of afterburn on the results. In a final test, the promoter of the invention was run again, this time with the top zone heater on the fluid bed set to 1300° F. to enable afterburning. The runs gave higher CO₂/CO as expected, but the NOx did not appear to change. With the CO conversion already high and the NH₃ concentration low, afterburning had little chance to influence the results overall.

1. A CO oxidation catalyst for the treatment of FCC regenerator flue gas so as to promote combustion of carbon monoxide while reducing the level of NOx in the flue gas comprising; a mixture of base metal oxides, said CO oxidation catalyst having an activity for carbon monoxide oxidation per weight of catalyst which is less than 10% and at least 0.2% of the activity for CO oxidation per unit weight of a catalyst comprising 500 ppm platinum on alumina at a temperature of at least 1100° F.

2. The catalyst of claim 1, wherein the activity of said CO oxidation catalyst per unit weight of catalyst is less than 1% of the activity for CO oxidation per unit weight of a catalyst comprising 500 ppm platinum on alumina at a temperature of at least 1100° F.

3. The catalyst of claim 1, wherein the mixture of base metals oxides contains less than 40 wt. % of copper oxides.

4. The catalyst of claim 1, wherein said mixture of base metal oxides is provided on a metal oxide support.

5. The catalyst of claim 4, wherein said metal oxide support comprises an FCC cracking catalyst.

6. The catalyst of claim 4, wherein said support comprises alumina.

7. The catalyst of claim 1, wherein said mixture of base metal oxides comprise less than 5 wt. % of said CO oxidation catalyst.

8. The castalyst of claim 7, wherein said mixture of base metal oxides comprise less than 3 wt. % of said CO oxidation catalyst.

9. The catalyst of claim 8, wherein said mixture of base metal oxides comprise up to about 2 wt. % of said CO oxidation catalyst.

10. The catalyst of claim 1, containing less than 75 ppm of precious metal.

11. The catalyst of claim 6, wherein said alumina is mixed with a diluent clay, optionally with a binder.

12. The catalyst of claim 1, in which the mixture of base metal oxides are not in the form of a perovskite.

13. The catalyst of claim 1, wherein said CO oxidation catalyst comprises a mixture of oxides of Fe or Mn with Cu and optionally X, where X is selected from base metals, rare earth metals, alkaline earth metals and mixtures thereof.

14. A method of regenerating an FCC cracking catalyst in a regenerator to burn off coke on the FCC catalyst and promote carbon monoxide oxidation in the flue gas without forming excessive NOx comprises contacting the flue gas with the CO oxidation catalyst of claim 1.

15. The method of claim 14, wherein the CO oxidation catalyst is a separate particle from the FCC cracking catalyst.

16. The method of claim 14, wherein the mixture of base metal oxides comprise less than 5 wt. % of the CO oxidation catalyst.

17. The method of claim 14, wherein said CO oxidation catalyst contains from 0 up to 75 ppm precious metal.

18. The method of claim 14, wherein said mixture of base metal oxides comprise less than about 40 wt. % copper oxide.

19. The method of claim 14, wherein said CO oxidation catalyst is a high temperature water gas shift catalyst.

20. The method of claim 14, wherein said CO oxidation catalyst comprises a mixture of oxides of Fe or Mn with Cu and optionally X, where X is selected from base metals, rare earth metals, alkaline earth metals and mixtures thereof.
